(19) United States
(12) Patent Application Publication
(10) Pub. No.: US 2024/0057520 A1
(43) Pub. Date: Feb. 22, 2024

(54) WEED CUTTING BLADE DEVICE

(71) Applicant: DAIWA KASEI INDUSTRY CO.,LTD., Okazaki-shi (JP)

(72) Inventors: Haruhisa KAMIYA, Okazaki-shi (JP); Toshio IWAHARA, Okazaki-shi (JP)

(21) Appl. No.: 18/447,542

(22) Filed: Aug. 10, 2023

(30) Foreign Application Priority Data
Aug. 22, 2022 (JP) 2022-131760

(51) Int. Cl. A01D 34/73; A01D 34/82; A01D 34/685

(52) U.S. Cl. CPC A01D 34/733; A01D 34/82; A01D 34/685

(57) ABSTRACT

Provided is a weed cutting blade device that can efficiently cut weeds while inhibiting stones from being caused to fly and a blade portion from being damaged. A lower plate of the weed cutting blade device has a plate-shaped outer periphery portion protruding outward from an upper plate. An outer periphery of the outer periphery portion includes an arc portion and a cutout portion shaped so as to be cut out with respect to a virtual circle which is a trajectory drawn by the arc portion as the lower plate rotates. The cutout portion is formed so as to overlap a blade portion of a rotary blade from a position on a front side with respect to the rotary blade in a rotation direction of the lower plate when viewed in a plan view.

### RELATED APPLICATIONS

This application claims the priority of Japanese Patent Application No. 2022-131760 filed on Aug. 22, 2022. The disclosure of the prior application is hereby incorporated herein in the entirety by reference.

### BACKGROUND OF THE INVENTION

### Field of the Invention

This disclosure relates to a weed cutting blade.

### Description of Related Art

Japanese Utility Model Registration No. 3079507 and Japanese Laid-Open Patent Publication No. 2000-50717 each propose a weed cutting blade device including: an upper plate and a lower plate provided so as to rotate around a center; guide pins each coupling the upper plate and the lower plate at a position eccentric from the center; and disk-shaped rotary blades provided between the upper plate and the lower plate so as to freely rotate around the guide pins and each having a blade portion on an outer periphery thereof, and the blade portion protrudes outward from the lower plate.

However, with the weed cutting blade device of Japanese Utility Model Registration No. 3079507, there is a risk that a stone may hit the blade portion deeply during weed cutting, causing the stone to fly upward. When the stone is caused to fly upward, the upwardly flying stone may hit a person or the like. In addition, if the blade portion hits a hard object (obstacle) such as a tree, a wall, and a fence, the blade portion may be severely damaged.

Therefore, an object of this disclosure is to provide a weed cutting blade device that includes an upper plate, a lower plate, a guide pin, and a rotary blade and that can efficiently cut weeds while inhibiting stones from being caused to fly upward and a blade portion from being damaged.

### SUMMARY OF THE INVENTION

A weed cutting blade device of this disclosure includes:
an upper plate and a lower plate provided so as to rotate around a center;
a guide pin coupling the upper plate and the lower plate at a position eccentric from the center; and
a disk-shaped rotary blade provided between the upper plate and the lower plate so as to freely rotate around the guide pin as an axis, and having a blade portion on an outer periphery thereof, the blade portion protruding outward from the lower plate, wherein
an outer periphery of the lower plate includes an arc portion formed in an arc shape along a circumferential direction around the center, and a cutout portion shaped so as to be cut out with respect to a virtual circle which is a trajectory drawn by the arc portion as the lower plate rotates, and
the cutout portion is formed so as to overlap the blade portion of the rotary blade from a position on a front side with respect to the rotary blade in a rotation direction of the lower plate when viewed in a plan view.

According to this, since the cutout portion is provided around the rotary blade on the outer periphery of the lower plate, the diameter of the lower plate (in other words, the distance between the arc portion and the rotation center of the lower plate) can be increased while the blade portion of the rotary blade is allowed to protrude to the outside of the lower plate. Since the diameter of the lower plate (arc portion) can be increased, stones can be pushed outward by the arc portion, so that stones can be inhibited from hitting the blade portion. Accordingly, stones can be inhibited from being caused to fly upward and the blade portion can be inhibited from being damaged. In addition, weeds bend outward in the radial direction of the lower plate when coming into contact with the arc portion, but when the contact with the arc portion is eliminated at the position of the cutout portion, the weeds can be displaced inward in the radial direction of the lower plate by the reaction of the bending. Accordingly, the weeds can be guided along the cutout portion to the blade portion, and can be efficiently cut.

### BRIEF DESCRIPTION OF THE DRAWINGS

FIG. 1 is a plan view of a weed cutting blade device;

FIG. 2 is a side view of the weed cutting blade device;

FIG. 3 is a cross-sectional view of the weed cutting blade device taken along a line in FIG. 1;

FIG. 4 is an exploded perspective view of the weed cutting blade device;

FIG. 5 is an enlarged view of a part A in FIG. 1 and shows a state where a rotary blade is at an outermost position;

FIG. 6 is an enlarged view of the part A in FIG. 1 and shows a state where the rotary blade is at an innermost position;

FIG. 7 is a bottom view (back view) of an upper plate;

FIG. 8 is a perspective view of a weed cutter;

FIG. 9 is a perspective view of a rotary blade of a first embodiment;

FIG. 10 is a plan view (top view) of the rotary blade of the first embodiment;

FIG. 11 is a front view of the rotary blade of the first embodiment;

FIG. 12 is a right side view of the rotary blade of the first embodiment;

FIG. 13 is a cross-sectional view of the rotary blade of the first embodiment taken along a line XIII-XIII in FIG. 10;

FIG. 14 is a cross-sectional view of a blade portion (protruding portion) of the rotary blade of the first embodiment taken along a line XIV-XIV in FIG. 10;

FIG. 15 is a cross-sectional view of the rotary blade of the first embodiment taken along a line XV-XV in FIG. 10;

FIG. 16 is a perspective view of a rotary blade of a second embodiment;

FIG. 17 is a plan view (top view) of the rotary blade of the second embodiment;

FIG. 18 is a front view of the rotary blade of the second embodiment;

FIG. 19 is a right side view of the rotary blade of the second embodiment;

FIG. 20 is a cross-sectional view of a blade portion (protruding portion) of the rotary blade of the second embodiment taken along a line XX-XX in FIG. 17;

FIG. 21 is a cross-sectional view of the rotary blade of the second embodiment taken along a line XXI-XXI in FIG. 17;

FIG. 22 is a cross-sectional view of the rotary blade of the second embodiment taken along a line XXII-XXII in FIG. 17;

FIG. 23 is a perspective view of a rotary blade of a third embodiment;

FIG. 24 is a plan view (top view) of the rotary blade of the third embodiment;

FIG. 25 is a front view of the rotary blade of the third embodiment;

FIG. 26 is a right side view of the rotary blade of the third embodiment;

FIG. 27 is a cross-sectional view of the rotary blade of the third embodiment taken along a line XXVII-XXVII in FIG. 24;

FIG. 28 is a cross-sectional view of the rotary blade of the third embodiment taken along a line XXVIII-XXVIII in FIG. 24;

FIG. 29 is a cross-sectional view of a blade portion (protruding portion) of the rotary blade of the third embodiment taken along a line XXIX-XXIX in FIG. 24;

FIG. 30 is a perspective view of a rotary blade of a fourth embodiment;

FIG. 31 is a plan view (top view) of the rotary blade of the fourth embodiment;

FIG. 32 is a front view of the rotary blade of the fourth embodiment;

FIG. 33 is a right side view of the rotary blade of the fourth embodiment;

FIG. 34 is a cross-sectional view of the rotary blade of the fourth embodiment taken along a line XXXIV-XXXIV in FIG. 31;

FIG. 35 is a cross-sectional view of the rotary blade of the fourth embodiment taken along a line XXXV-XXXV in FIG. 31;

FIG. 36 is a cross-sectional view of a blade portion (protruding portion) of the rotary blade of the fourth embodiment taken along a line XXXVI-XXXVI in FIG. 31; and

FIG. 37 is a perspective view of a weed cutting blade device of a fifth embodiment.

### DETAILED DESCRIPTION

### First Embodiment

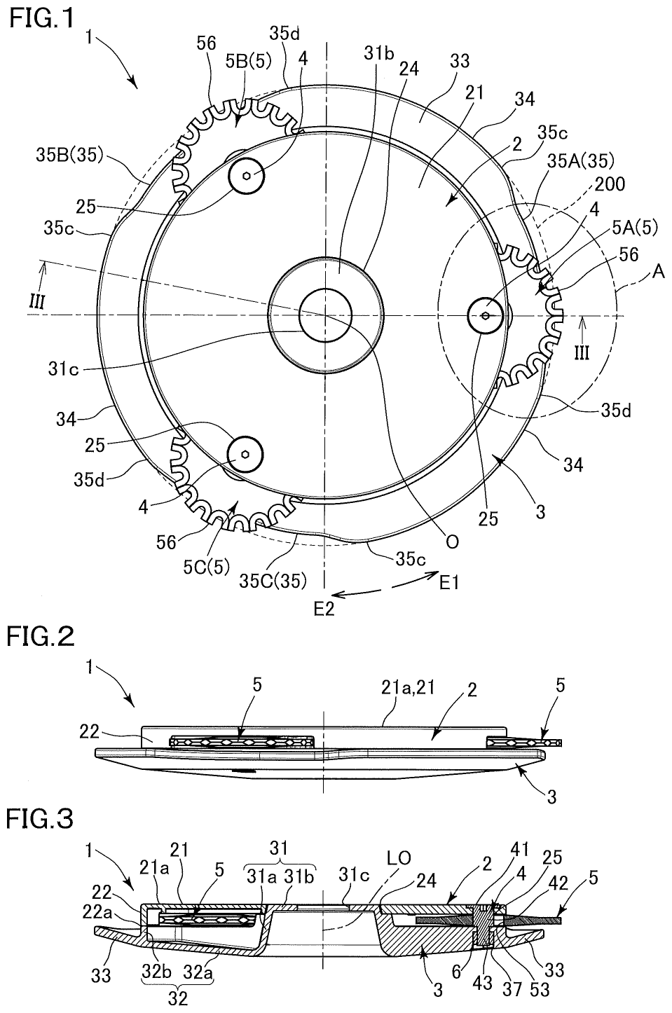

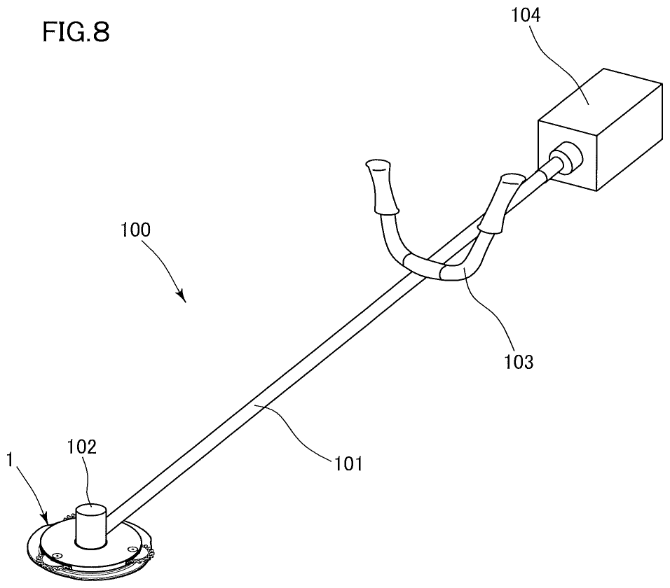

Hereinafter, a first embodiment of this disclosure will be described with reference to the drawings. FIG. 1 to FIG. 4 show a weed cutting blade device 1 of this embodiment. The weed cutting blade device 1 forms a part of a hand-held (handy-type) weed cutter 100 illustrated in FIG. 8. The weed cutter 100 includes a shaft 101, a drive shaft 102 provided at a front end of the shaft 101, a handle 103 provided at the middle of the shaft 101, and a drive source 104 provided at a rear end of the shaft 101. The weed cutting blade device 1 is attached to the drive shaft 102 at the front end of the shaft 101. The weed cutting blade device 1 is attached such that the drive shaft 102 is fitted into a center hole 31c (see FIG. 1 and FIG. 3) of the weed cutting blade device 1. The drive shaft 102 rotates the weed cutting blade device 1 around a center line L0 (see FIG. 3) of the weed cutting blade device 1 by its own rotation.

The drive source 104 is an engine, a motor, or the like that rotationally drives the drive shaft 102. The shaft 101 has a pipe shape, and a transmission shaft (not shown) for transmitting driving force from the drive source 104 to the drive shaft 102 is provided inside the shaft 101. The handle 103 is a part that is grasped by the user of the weed cutter 100 in order to control the orientations and the positions of the shaft 101 and the weed cutting blade device 1 at the front end thereof. The weed cutting blade device 1 is used so as to move along weedy ground by operating the handle 103.

As shown in FIG. 1 to FIG. 4, the weed cutting blade device 1 includes an upper plate 2, a lower plate 3, guide pins 4, rotary blades 5, and nuts 6. The entirety of the upper plate 2 is formed from a resin, for example, but a part or the entirety thereof may be formed from a metal. The upper plate 2 is provided above the lower plate 3 so as to oppose the lower plate 3. In addition, when viewed in a plan view in FIG. 1, a center O of the upper plate 2 coincides with the center of the lower plate 3. The center O is a point on the center line L0 in FIG. 3. In the following, the center of the lower plate 3 is sometimes indicated by reference character “0”.

The upper plate 2 has an upper surface portion 21 and a side surface portion 22. The upper surface portion 21 is formed in a circular plate shape in a plan view. The upper surface portion 21 is provided so as to be spaced apart from the lower plate 3 in the up-down direction such that a space for placing the rotary blades 5 is formed between the lower plate 3 and the upper surface portion 21. A through hole 24 (hereinafter, sometimes referred to as center hole) is formed at the center of the upper surface portion 21. An upper end portion 31b of a center portion 31 of the lower plate 3 is fitted into the center hole 24 (see FIG. 3). The upper end portion 31b is fitted into the center hole 24 so as to be flush with an upper surface 21a of the upper surface portion 21. The diameter of the upper surface portion 21 (upper plate 2) is smaller than the diameter of the lower plate 3 (diameter of a virtual circle 200 described later). The diameter of the upper plate 2 may be equal to the diameter of the lower plate 3 or larger than the diameter of the lower plate 3.

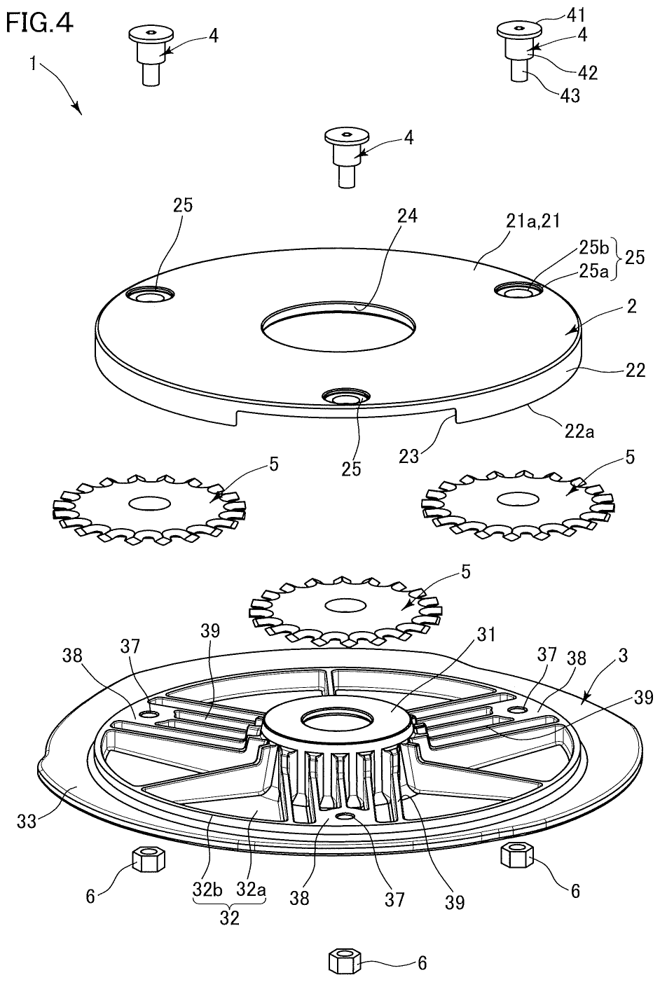

A plurality of through holes 25 (hereinafter, sometimes referred to as outer periphery holes) are formed at the outer periphery of the upper surface portion 21. In this embodiment, three outer periphery holes 25 are formed. The plurality of outer periphery holes 25 are formed at equal intervals (i.e., 120° intervals) along the circumferential direction of the upper surface portion 21. As shown in FIG. 4, each outer periphery hole 25 includes a large-diameter hole 25a located on the upper surface 21a side of the upper surface portion 21 and a small-diameter hole 25b located on the lower surface (back surface) side of the upper surface portion 21. The large-diameter hole 25a and the small-diameter hole 25b are formed coaxially. The small-diameter hole 25b is formed with a diameter smaller than that of the large-diameter hole 25a. The outer periphery hole 25 is a hole for fitting the guide pin 4. Specifically, a head portion 41 (see FIG. 4) of the guide pin 4 is fitted into the large-diameter hole 25a. The head portion 41 is fitted into the outer periphery hole 25 (large-diameter hole 25a) so as to be flush with the upper surface 21a of the upper surface portion 21 (see FIG. 3). A middle portion 42 (see FIG. 4) of the guide pin 4 is fitted into the small-diameter hole 25b.

The upper surface 21a of the upper surface portion 21 is formed as a surface having no irregularities or steps, except for the center hole 24 and the outer periphery holes 25. Specifically, the upper surface 21a has no step surface parallel to the rotation center line L0, except for the center hole 24 and the outer periphery holes 25. In addition, the upper surface 21a does not have a portion (projection portion) displaced upward and then downward, or a portion (recessed portion) displaced downward and then upward, from the inner side toward the outer side in the radial direction of the upper plate 2 or along the circumferential direction of the upper plate 2. Also, the upper surface 21a does not have a plurality of horizontal surfaces (surfaces perpendicular to the rotation center line L0) whose positions are different from each other in the up-down direction, except for the center hole 24 and the outer periphery holes 25.

More specifically, a portion of the upper surface 21a other than the center hole 24 and the outer periphery holes 25 is formed as a flat surface (horizontal surface) perpendicular to the rotation center line L0 (see FIG. 3) of the upper plate 2 and the lower plate 3. That is, the upper surface 21a does not have irregularities, steps, or slopes in the up-down direction, which is the direction of the rotation center line L0, except for the center hole 24 and the outer periphery holes 25. As described above, the guide pin 4 is fitted into each outer periphery hole 25 so as to be flush with the upper surface 21a, and the center portion 31 of the lower plate 3 is fitted into the center hole 24 so as to be flush with the upper surface 21a. Furthermore, the drive shaft 102 is fitted into the center hole 31c, which is formed in the center portion 31, and the center hole 31c is hidden by the drive shaft 102. Therefore, in a state where the weed cutting blade device 1 is attached to the weed cutter 100, in the upper surface 21a (including the upper surface of each guide pin 4), no irregularities or steps exist other than the drive shaft 102, in other words, no step surface (surface parallel to the rotation center line L0) perpendicular to the horizontal surface exists.

FIG. 1 to FIG. 4 show an example in which the entirety of the upper surface 21a (including the upper surface of each guide pin 4) is formed as a flat surface perpendicular to the rotation center line L0. In other words, the upper surface 21a (including the upper surface of each guide pin 4) in the example in FIG. 1 to FIG. 4 is formed as a surface whose position in the up-down direction does not change along the circumferential direction around the rotation center line L0 and whose position in the up-down direction does not change along the radial direction. However, the upper surface 21a is not limited to the example in FIG. 1 to FIG. 4 as long as the upper surface 21a is a surface having no irregularities or steps along the circumferential direction and the radial direction. Specifically, for example, the entirety of the upper surface 21a (except for through holes such as the center hole 24 and the outer periphery holes 25) may be formed as a downwardly inclined surface whose position in the up-down direction does not change along the circumferential direction around the rotation center line L0 and which is gradually displaced downward as extending from the inner side toward the outer side in the radial direction (not including a horizontal surface perpendicular to the rotation center line L0 and a step surface parallel to the rotation center line L0). In this case, the downwardly inclined surface may be a surface that draws a straight line along the radial direction or may be a surface that draws a curved line. In addition, the inclination angle of the downwardly inclined surface may be the same at any position along the circumferential direction around the rotation center line L0.

Also, for example, the entirety of the upper surface 21a (except for through holes such as the center hole 24 and the outer periphery holes 25) may be formed as an upwardly inclined surface whose position in the up-down direction does not change along the circumferential direction around the rotation center line L0 and which is gradually displaced upward as extending from the inner side toward the outer side in the radial direction (not including a horizontal surface perpendicular to the rotation center line L0 and a step surface parallel to the rotation center line L0). In this case, the upwardly inclined surface may be a surface that draws a straight line along the radial direction or may be a surface that draws a curved line. In addition, the inclination angle of the upwardly inclined surface may be the same at any position along the circumferential direction around the rotation center line L0.

Also, for example, the upper surface 21a (except for through holes such as the center hole 24 and the outer periphery holes 25) may be formed such that the position in the up-down direction thereof does not change along the circumferential direction around the rotation center line L0, a section in the radial direction of the upper surface 21a is formed as a horizontal surface, and the remaining section of the upper surface 21a is formed as a downwardly inclined surface. In this case, the inner side in the radial direction of the upper surface 21a may be formed as a horizontal surface, and the outer side in the radial direction of the upper surface 21a may be formed as a downwardly inclined surface, or conversely, the inner side in the radial direction of the upper surface 21a may be formed as a downwardly inclined surface, and the outer side in the radial direction of the upper surface 21a may be formed as a horizontal surface. In this case, the upper surface 21a may not necessarily include an upwardly inclined surface.

Also, for example, the upper surface 21a (except for through holes such as the center hole 24 and the outer periphery holes 25) may be formed such that the position in the up-down direction thereof does not change along the circumferential direction around the rotation center line L0, a section in the radial direction of the upper surface 21a is formed as a horizontal surface, and the remaining section in the radial direction of the upper surface 21a is formed as an upwardly inclined surface. In this case, the inner side in the radial direction of the upper surface 21a may be formed as a horizontal surface, and the outer side in the radial direction of the upper surface 21a may be formed as an upwardly inclined surface, or conversely, the inner side in the radial direction of the upper surface 21a may be formed as an upwardly inclined surface, and the outer side in the radial direction of the upper surface 21a may be formed as a horizontal surface. In this case, the upper surface 21a may not necessarily include a downwardly inclined surface.

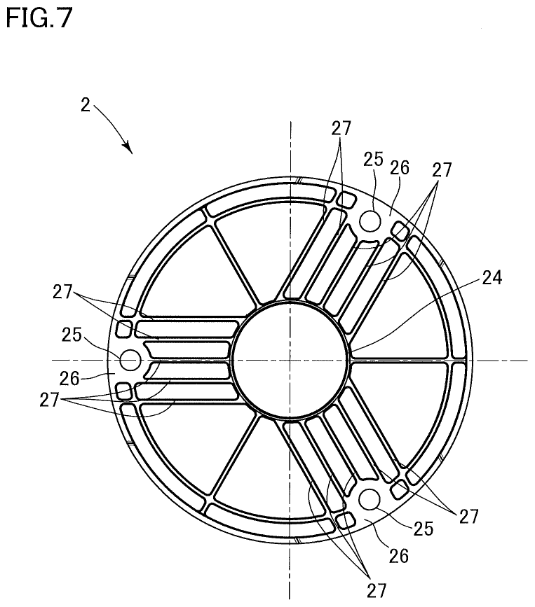

As shown in FIG. 7, the upper surface portion 21 has, on the back surface side thereof, a hole-surrounding portion 26 surrounding each outer periphery hole 25. The hole-surrounding portion 26 is formed as a flat surface perpendicular to the rotation center line L0. The hole-surrounding portion 26 comes into contact with a center portion of the upper surface of the rotary blade 5 to restrict upward movement of the rotary blade 5.

Furthermore, as shown in FIG. 7, the upper surface portion 21 has a plurality of ribs 27 protruding downward from the back surface thereof. The ribs 27 are provided so as to extend in the radial direction of the upper surface portion 21. Specifically, the ribs 27 are provided so as to connect between the respective hole-surrounding portions 26 and the center hole 24. A plurality of ribs 27 are provided at each hole-surrounding portion 26. A distal end in the protruding direction from the back surface of the upper surface portion 21 (end portion on the lower side in the up-down direction) of each rib 27 is provided so as to be flush with the hole-surrounding portion 26. A proximal end (end portion on the upper side in the up-down direction) of each rib 27 is located above the hole-surrounding portion 26. The distal end of each rib 27 comes into contact with the upper surface of the rotary blade 5, or opposes the upper surface of the rotary blade 5 with a slight gap between the upper surface of the rotary blade 5 and the distal end of the rib 27. The rib 27 increases the rigidity of the upper plate 2 and also serves as a restriction portion that restricts upward movement of the rotary blade 5.

The side surface portion 22 is formed so as to extend from the outer periphery of the upper surface portion 21 in a downward direction (direction toward the lower plate 3) in a direction parallel to the rotation center line L0. In addition, the side surface portion 22 is formed in an arc shape along the outer periphery of the upper surface portion 21. In the side surface portion 22, a cutout 23 for allowing each rotary blade 5 to protrude outside is formed (see FIG. 4). The cutout 23 is formed so as to penetrate between the outer surface and the inner surface of the side surface portion 22. The cutout 23 is also formed in a shape in which the lower side is open. The number of cutouts 23 formed is equal to the number of rotary blades 5 (i.e., three). The three cutouts 23 are formed at equal intervals (i.e., 120° intervals) in the circumferential direction around the rotation center line L0.

In a state where the upper plate 2 and the lower plate 3 are coupled to each other, a lower end 22a (see FIG. 3 and FIG. 4) of the side surface portion 22 is in contact with the upper surface of the lower plate 3. Specifically, the lower end 22a is in contact with the upper end of an outer periphery wall portion 32b (see FIG. 3 and FIG. 4) of a body portion 32 of the lower plate 3 described later. That is, the side surface portion 22 serves as a closing portion that closes the outer periphery of the space formed between the upper surface portion 21 and the lower plate 3 (except for the positions where the rotary blades 5 are provided (cutouts 23)).

The upper plate 2 is driven by the drive shaft 102 (see FIG. 8) to rotate together with the lower plate 3 and each rotary blade 5 in a counterclockwise direction E1 around the center O when viewed in the plan view in FIG. 1.

The entirety of the lower plate 3 is formed from a resin, for example, but a part or the entirety thereof may be formed from a metal. The lower plate 3 is provided below the upper plate 2 so as to oppose the upper plate 2. In addition, the diameter of the lower plate 3 (the diameter of the virtual circle 200 described alter) is larger than the diameter of the upper plate 2.

The lower plate 3 includes the center portion 31, the body portion 32, and an outer periphery portion 33. The center portion 31 is provided at the center position of the lower plate 3 (body portion 32) so as to protrude upward. As shown in FIG. 3, the center portion 31 has a tubular portion 31a surrounding the entire circumference around the rotation center line L0 in a circular shape, and the upper end portion 31b extending radially inward from the upper end of the tubular portion 31a and formed in a ring shape (circular shape) around the rotation center line L0. The lower end of the tubular portion 31a forms an opening that communicates with the inner space of the tubular portion 31a.

As shown in FIG. 3, the upper end portion 31b is fitted into the center hole 24 of the upper plate 2. A hole 31c for attaching the drive shaft 102 (see FIG. 8) is formed at the center of the upper end portion 31b. The upper end portion 31b and the hole 31c may be formed as a part of the upper plate 2.

The body portion 32 of the lower plate 3 has a body bottom portion 32a and the outer periphery wall portion 32b. The body bottom portion 32a is provided so as to surround the entire circumference of the center portion 31 in a ring shape (circular shape) and extend radially outward from the lower end of the center portion 31. The body bottom portion 32a is formed in a plate shape. The outer periphery of the body bottom portion 32a draws a circle centered on the rotation center line L0. As shown in FIG. 3, the lower surface (surface on the side opposite to the side opposing the upper plate 2) of the body bottom portion 32a is formed in an inclined shape that is gradually displaced upward with increasing distance from the rotation center line L0. This inclined surface may be a surface that draws a straight line along the radial direction of the lower plate 3, or may be a surface that draws a curved line, when viewed in a cross-section in FIG. 3. In addition, the inclined surface is formed over the entire circumference around the rotation center line L0. Moreover, an inclination angle of the lower surface of the body portion 32 with respect to a contact surface is, for example, 30° or less. The inclination angle is the same at any position along the circumferential direction around the rotation center line L0.

The outer periphery wall portion 32b (see FIG. 3 and FIG. 4) of the body portion 32 is formed in a shape protruding upward from the outer periphery of the body bottom portion 32a. In addition, the outer periphery wall portion 32b is formed along the outer periphery of the body bottom portion 32a so as to draw a circle (ring shape) centered on the rotation center line L0, in other words, the outer periphery wall portion 32b is formed over the entire circumference around the rotation center line L0. As described above, the upper end of the outer periphery wall portion 32b and the lower end 22a of the side surface portion 22 of the upper plate 2 are in contact with each other. The outer periphery wall portion 32b, together with the side surface portion 22 of the upper plate 2, serves as a closing portion that closes the outer periphery of the space formed between the upper plate 2 and the lower plate 3.

As shown in FIG. 4, in the body bottom portion 32a, a hole 37 (hereinafter, sometimes referred to as outer periphery hole) is formed so as to penetrate between the upper surface and the lower surface of the body bottom portion 32a. The number of outer periphery holes 37 formed is equal to the number of rotary blades 5 (i.e., three). The plurality of outer periphery holes 37 are formed on the outer periphery side of the body bottom portion 32a (at positions close to the outer periphery wall portion 32b) at equal intervals (in this embodiment, 120° intervals) in the circumferential direction around the rotation center line L0. In addition, each outer periphery hole 37 is formed so as to be located coaxially with the outer periphery hole 25 of the upper plate 2. The outer periphery hole 37 is a hole for fitting the guide pin 4. Specifically, a tip side portion 43 (see FIG. 4) of the guide pin 4 and the nut 6 to be fitted therewith are fitted into the outer periphery hole 37 (see FIG. 3).

As shown in FIG. 4, the body bottom portion 32a has, on the upper surface side thereof, a hole-surrounding portion 38 surrounding each outer periphery hole 37. The hole-surrounding portion 38 is formed as a flat surface perpendicular to the rotation center line L0. The hole-surrounding portion 38 is a restriction portion that comes into contact with a center portion of the lower surface of the rotary blade 5 to restrict downward movement of the rotary blade 5. The hole-surrounding portion 38 also serves as a placement surface on which the rotary blade 5 is placed.

Furthermore, as shown in FIG. 4, the body bottom portion 32a has a plurality of ribs 39 protruding upward from the upper surface thereof. The ribs 39 are provided so as to extend in the radial direction of the body bottom portion 32a. Specifically, the ribs 39 are provided so as to connect between the respective hole-surrounding portions 38 and the center portion 31. A plurality of ribs 39 are provided at each hole-surrounding portion 38. A distal end (end portion on the upper side in the up-down direction) of each rib 39 is provided so as to be flush with the hole-surrounding portion 38. A proximal end (end portion on the lower side in the up-down direction) of each rib 39 is located below the hole-surrounding portion 38. The distal end (upper end) of each rib 39 comes into contact with the lower surface of the rotary blade 5, or opposes the lower surface of the rotary blade 5 with a slight gap between the lower surface of the rotary blade 5 and the rib 39. The rib 39 increases the rigidity of the lower plate 3 and also serves as a restriction portion that restricts downward movement of the rotary blade 5.

The outer periphery portion 33 of the lower plate 3 is formed so as to extend radially outward further from the outer periphery of the body portion 32 (body bottom portion 32a). The outer periphery portion 33 also protrudes outward from the upper plate 2 over the entire circumference around the center O or the rotation center line L0. The outer periphery portion 33 is connected to the lower end of the outer periphery wall portion 32b of the body portion 32. The outer periphery portion 33 is a portion for inhibiting obstacles such as small stones from hitting a blade portion 56 (see FIG. 1) of the rotary blades 5 and for guiding weeds to the blade portion 56. The outer periphery portion 33 is formed in a ring shape along the outer periphery (outer periphery wall portion 32b) of the body portion 32. The outer periphery portion 33 is also formed over the entire circumference in the circumferential direction around the rotation center line L0. Moreover, the outer periphery portion 33 is formed in a plate shape. Furthermore, the upper surface and the lower surface of the outer periphery portion 33 are each formed in an inclined shape that is gradually displaced upward with increasing distance from the rotation center line L0. This inclined surface may be a surface that draws a straight line along the radial direction of the lower plate 3, or may be a surface that draws a curved line, when viewed in the cross-section in FIG. 3. An inclination angle of the lower surface of the outer periphery portion 33 with respect to the contact surface may be different from or equal to that of the body bottom portion 32a. The inclination angle of the outer periphery portion 33 may be larger than that of the body bottom portion 32a. The inclination angle of the outer periphery portion 33 is, for example, 45° or less. In addition, the inclination angle is the same at any position along the circumferential direction around the rotation center line L0. In this embodiment (example in FIG. 3), the inclination angle of the lower surface of the outer periphery portion 33 is larger than that of the body bottom portion 32a.

As shown in FIG. 1, an outer peripheral edge portion of the outer periphery portion 33 includes an arc portion 34 formed in an arc shape along the circumferential direction around the center O (rotation center line L0) of the lower plate 3, and a cutout portion 35 shaped so as to be cut out with respect to the arc portion 34 or the virtual circle 200 which is a trajectory drawn by the arc portion 34 as the lower plate 3 rotates. The cutout portion 35 is formed at a position around the rotary blade 5 in the circumferential direction around the center O (rotation center line L0). The arc portion 34 is formed at a position between one rotary blade 5 and a rotary blade 5 adjacent thereto in the circumferential direction. The number of cutout portions 35 formed is equal to the number of rotary blades 5 (in this embodiment, three). The plurality of (three) cutout portions 35 are formed at equal intervals (in this embodiment, 120° intervals) in the circumferential direction around the center O of the lower plate 3. The number of arc portions 34 formed is equal to the number of cutout portions 35 (in this embodiment, three). The plurality of (three) arc portions 34 are formed at equal intervals (in this embodiment, 120° intervals) in the circumferential direction of the lower plate 3. Each cutout portion 35 is formed at the position between the arc portions 34. Each arc portion 34 is formed at the position between the cutout portions 35.

In the following, the three rotary blades 5 are sometimes distinguished by reference characters “5A”, “5B”, and “5C” as shown in FIG. 1. In addition, the three cutout portions 35 are sometimes distinguished by reference characters “35A”, “35B”, and “35C” as shown in FIG. 1. Moreover, an end portion 35c, of the cutout portion 35, located on the rotation direction E1 side is defined as a front end, and an end portion 35d, of the cutout portion 35, located on the opposite side to the rotation direction E1 is defined as a rear end. A first cutout portion 35A is formed at a position around a first rotary blade 5A. A second cutout portion 35B is formed at a position around a second rotary blade 5B. A third cutout portion 35C is formed at a position around a third rotary blade 5C.

The front end 35c of the first cutout portion 35A may be formed, for example, closer to the first rotary blade 5A than the rear end 35d of the second cutout portion 35B and the second rotary blade 5B located on the front side in the rotation direction E1 are. In addition, the front end 35c of the first cutout portion 35A may be formed farther from the first rotary blade 5A than the rear end 35d of the first cutout portion 35A is. In other words, the distance between the front end 35c of the first cutout portion 35A and the center of the guide pin 4 on which the first rotary blade 5A is mounted may be larger than the distance between the rear end 35d of the first cutout portion 35A and the center of the guide pin 4. Furthermore, when viewed in the plan view in FIG. 1, for example, a virtual straight line (not shown) connecting the front end 35c of the first cutout portion 35A and the center O of the lower plate 3 may not necessarily intersect the first rotary blade 5A. Also, for example, a virtual straight line (not shown) connecting the rear end 35d of the first cutout portion 35A and the center O of the lower plate 3 may intersect the first rotary blade 5A.

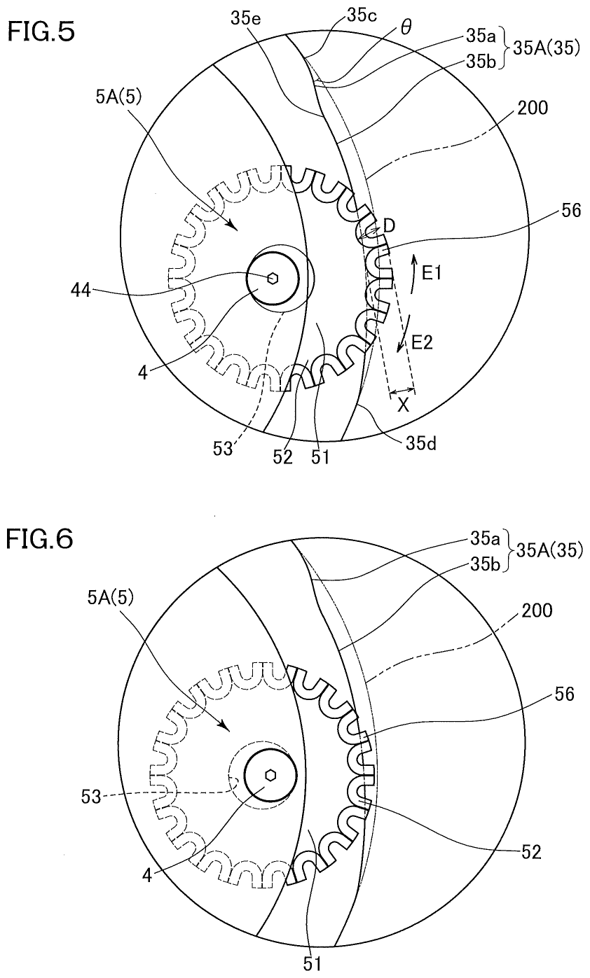

More specifically, the first cutout portion 35A is formed such that the blade portion 56 located at the outer periphery of the first rotary blade 5A is allowed to protrude to the outside of the lower plate 3. When viewed in the plan view in FIG. 1, the first cutout portion 35A is formed so as to extend in a direction E2, which is opposite to the rotation direction E1 of the lower plate 3, from a position on the front side with respect to the first rotary blade 5A in the rotation direction E1 toward the blade portion 56, of the first rotary blade 5A, located on the radially outer side with respect to the guide pin 4. More specifically, the first cutout portion 35A includes a first portion 35a forming a part thereof from the front end 35c, and a second portion 35b changing the direction to the side approaching the virtual circle 200 from the first portion 35a and extending to the rear end 35d while overlapping (crossing) the blade portion 56 of the first rotary blade 5A when viewed in a plan view in FIG. 5. The rear end 35d is located on the rear side (opposite side) in the rotation direction E1 with respect to the first rotary blade 5A.

The first portion 35a is located on the front side in the rotation direction E1 with respect to the first rotary blade 5A. The first portion 35a is formed such that the distance thereof from the virtual circle 200 gradually increases toward the direction E2 opposite to the rotation direction E1. In addition, the range of the first portion 35a along the circumferential direction around the center O is smaller than that of the second portion 35b. Here, a virtual straight line (not shown) connecting the front end 35c and the center O of the lower plate 3 is defined as a first virtual straight line. In addition, a virtual straight line (not shown) connecting the front end 35c and a center 44 (see FIG. 5) of the guide pin 4 on which the first rotary blade 5A is mounted (in other words, the center of the outer periphery hole 37 into which the guide pin 4 is fitted) is defined as a second virtual straight line. An angle θ (see FIG. 5) formed between the first portion 35a and the virtual circle 200 may be smaller than an angle formed between the first virtual straight line and the virtual circle 200. In addition, the angle θ may be smaller than an angle formed between the second virtual straight line and the virtual circle 200.

As shown in FIG. 5, the second portion 35b is formed so as to gradually approach the virtual circle 200 as extending from a position 35e (boundary between the first portion 35a and the second portion 35b) on the front side with respect to the first rotary blade 5A toward the direction E2 opposite to the rotation direction E1. Specifically, the second portion 35b is formed in an arc shape that gradually expands outward. The center (not shown) of a circle corresponding to the arc of the second portion 35b is set on the center side of the virtual circle 200 (inside the virtual circle 200).

The first cutout portion 35A (the first portion 35a and the second portion 35b) may be formed so as not to overlap an inner portion 51 of the first rotary blade 5A described later, when viewed in the plan view in FIG. 5. In other words, the second portion 35b may be formed so as not to overlap the inner portion 51 of the first rotary blade 5A but to overlap only an outer periphery portion 52, of the first rotary blade 5A, in which the blade portion 56 is formed. As described later, a center hole 53 (see FIG. 5 and FIG. 6), of the rotary blade 5, into which the guide pin 4 is inserted is formed with a diameter larger than that of the guide pin 4. FIG. 5 shows a state where the first rotary blade 5A protrudes to the outermost side. The first cutout portion 35A may be formed so as to overlap only the outer periphery portion 52 of the first rotary blade 5A even when the first rotary blade 5A is at the outermost position. In addition, FIG. 6 shows a state where the first rotary blade 5A is retracted to the innermost side. The first cutout portion 35A may be formed so as to overlap only the outer periphery portion 52 of the first rotary blade 5A even when the first rotary blade 5A is at the innermost position.

The second cutout portion 35B and the third cutout portion 35C are formed in the same shape as the first cutout portion 35A. In addition, the three arc portions 34 are formed in shapes (with curvatures and arc lengths) that are the same as each other. Furthermore, the range of one cutout portion 35 in the circumferential direction around the center O (in other words, the arc length of the virtual circle 200 cut by the front end 35c and the rear end 35d of the cutout portion 35) is the same as the arc length (range in the circumferential direction around the center O) of one arc portion 34. The range in the circumferential direction of the cutout portion 35 may be smaller or larger than the range in the circumferential direction of the arc portion 34, depending on conditions such as the rotational speed and the diameter of the lower plate 3.

As described above, the diameter of the lower plate 3 at a portion around the rotary blade 5 (i.e., the cutout portion 35) is smaller than the diameter of the lower plate 3 at a portion between one rotary blade 5 and a rotary blade 5 adjacent thereto (i.e., the arc portion 34). Conversely, the diameter of the lower plate 3 at the portion between the one rotary blade 5 and the rotary blade 5 adjacent thereto is larger than the diameter thereof at the portion around the rotary blade 5. The cutout portion 35 is a small-diameter portion whose distance to the center O is smaller than that of the arc portion 34. The arc portion 34 is a large-diameter portion whose distance to the center O is larger than that of the cutout portion 35. Thus, the lower plate 3 includes the small-diameter portion 35 and the large-diameter portion 34 along the circumferential direction around the center O. The small-diameter portion 35 is formed so as to overlap (intersect) the blade portion 56 of the rotary blade 5 from the front side of the rotary blade 5 in the opposite direction E2 when viewed in a plan view. The large-diameter portion 34 is formed so as not to overlap the blade portion 56 when viewed in a plan view.

Each guide pin 4 is a pin that couples the upper plate 2 and the lower plate 3 at a position eccentric from the center O of the upper plate 2 and the lower plate 3 and that serves as the axis of the rotary blade 5. The axial line of the guide pin 4 is parallel to the rotation center line L0 of the upper plate 2 and the lower plate 3. The number of guide pins 4 provided is equal to the number of rotary blades 5 (in this embodiment, three). Each guide pin 4 is inserted into the outer periphery hole 25 of the upper plate 2 and the outer periphery hole 37 of the lower plate 3 (see FIG. 3). The guide pin 4 is inserted into the outer periphery holes 25 and 37 from the upper plate 2 side.

As shown in FIG. 4, each guide pin 4 has the head portion 41, the middle portion 42, and the tip side portion 43. These portions 41 to 43 are formed coaxially. The head portion 41 is formed with a diameter larger than those of the middle portion 42 and the tip side portion 43. The head portion 41 is fitted into the large-diameter hole 25a (see FIG. 4) of the outer periphery hole 25 of the upper plate 2. The middle portion 42 is formed with a diameter smaller than that of the head portion 41 and larger than that of the tip side portion 43. The middle portion 42 is fitted into the small-diameter hole 25b (see FIG. 4) of the outer periphery hole 25 of the upper plate 2 and also is inserted into the center hole 53 of the rotary blade 5 (see FIG. 3). The diameter of the middle portion 42 is smaller than that of the center hole 53. The tip side portion 43 is formed with a diameter smaller than those of the head portion 41 and the middle portion 42. The tip side portion 43 is fitted into the outer periphery hole 37 of the lower plate 3. In addition, the tip side portion 43 is formed as a male screw portion having a screw groove formed on an outer periphery thereof. The tip side portion 43 is fitted with the nut 6 in the outer periphery hole 37 of the lower plate 3 (see FIG. 3). The upper plate 2 and the lower plate 3 form a unitary rotary plate by fastening the guide pins 4 and the nuts 6 to each other. The upper plate 2 and the lower plate 3 can be separated from each other by unfastening the guide pins 4 and the nuts 6.

Each rotary blade 5 forms a blade for a weed cutter (weed cutting blade). The plurality of rotary blades 5 are provided at equal intervals in the circumferential direction of the upper plate 2 and the lower plate 3. In this embodiment, the three rotary blades 5 are provided. The plurality of rotary blades 5 have shapes that are the same as each other. The entirety of each rotary blade 5 is formed from a resin, for example. The blade portion 56 of the rotary blade 5 may be formed from a resin, and the other portion thereof may be formed from a metal. Alternatively, the entirety of the rotary blade 5 may be formed from a metal.

The rotary blade 5 is interposed between the upper plate 2 and the lower plate 3 and is provided so as to freely rotate around the guide pin 4 as an axis. That is, the rotary blade 5 is provided so as to be rotatable around the guide pin 4 independently of the upper plate 2 and the lower plate 3.

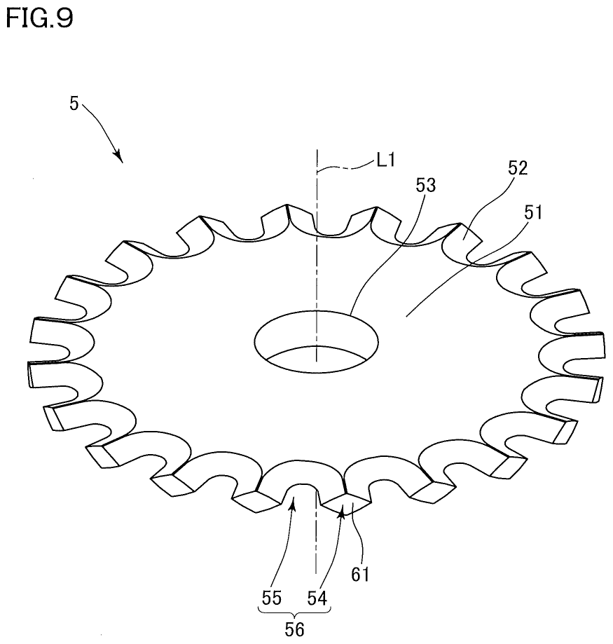

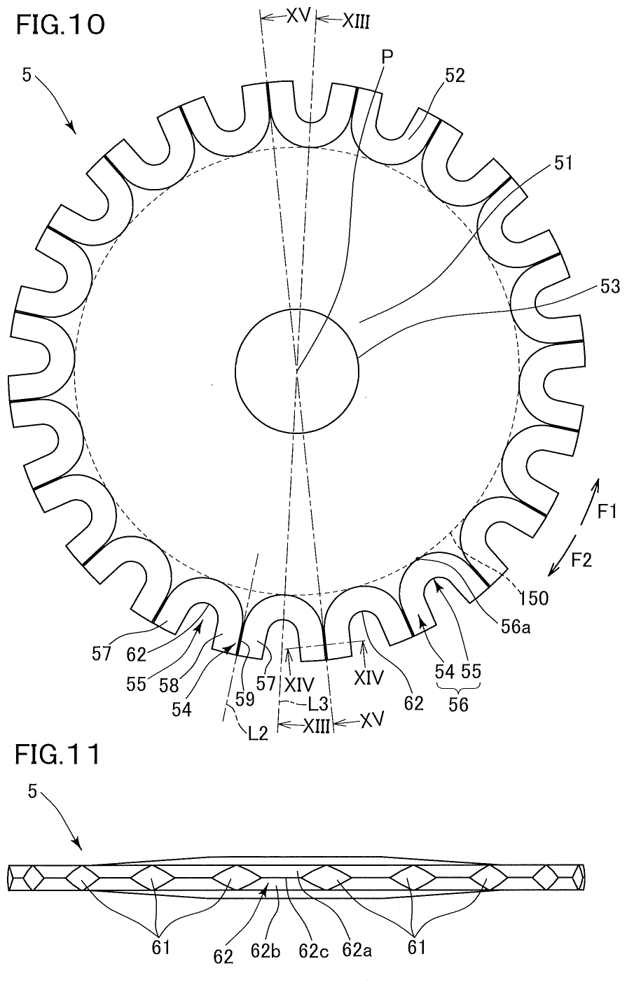

Specifically, the rotary blade 5 is formed in a disk shape having a diameter smaller than those of the upper plate 2 and the lower plate 3. As shown in FIG. 9 to FIG. 12, the rotary blade 5 includes the disk-shaped inner portion 51 and the outer periphery portion 52 provided along the outer periphery of the inner portion 51. The through hole 53 (hereinafter, sometimes referred to as center hole) is formed at the center of the inner portion 51 as a mounting hole penetrating in the direction of a center line L1 of the inner portion 51. The center hole 53 is formed in a circular shape in a plan view in FIG. 10. The diameter of the center hole 53 is larger than that of the middle portion 42 of the guide pin 4. Therefore, the rotary blade 5 is provided so as to be movable in a direction perpendicular to the center line L1 of the rotary blade 5 (in other words, the axial line of the guide pin 4) by the difference between the diameter of the center hole 53 and the diameter of the middle portion 42.

As shown in FIG. 13, the inner portion 51 has a hole-surrounding portion 51a surrounding the center hole 53, and a middle portion 51b located between the hole-surrounding portion 51a and the outer periphery portion 52. The hole-surrounding portion 51a is formed as a flat surface perpendicular to the center line L1. The hole-surrounding portion 26 (see FIG. 7) of the upper plate 2 or the hole-surrounding portion 38 (see FIG. 4) of the lower plate 3 comes into contact with the hole-surrounding portion 51a. As shown in FIG. 13, the middle portion 51b includes an inclined surface that is inclined relative to a virtual horizontal plane perpendicular to the center line L1 such that the width thereof in the direction of the center line L1 of the inner portion 51 gradually decreases from the hole-surrounding portion 51a toward the radially outer side. The inclined surface 51b is formed over the entire circumference around the center line L1. In addition, an inclination angle of the inclined surface 51b with respect to the virtual horizontal plane is the same at any position in the circumferential direction around the center line L1. In FIG. 10, the boundary position between the inner portion 51 and the outer periphery portion 52 is shown by a broken line 150. The broken line 150 is a circle passing through a point 56a, closest to a center P, on a surface forming the blade portion 56 of the rotary blade 5. The middle portion 51b may be formed as an inclined surface to the boundary position 150 between the inner portion 51 and the outer periphery portion 52, or may be formed as an inclined surface to a position before the boundary position 150 and formed on the outer side of the inclined surface as a flat surface perpendicular to the center line L1.

The outer periphery portion 52 has the blade portion 56 along the circumferential direction. The blade portion 56 has a plurality of protruding portions 54 at equal intervals in the circumferential direction around the center P (see FIG. 10) of the rotary blade 5. The center P is located on the center line L1 of the rotary blade 5. In this embodiment, 20 protruding portions 54 are formed. In other words, the blade portion 56 has a plurality of cut portions 55 at equal intervals in the circumferential direction around the center P. Each cut portion 55 is formed between one protruding portion 54 and a protruding portion 54 adjacent thereto. The plurality of protruding portions 54 are formed in shapes that are the same as each other. In addition, the plurality of cut portions 55 are formed in shapes that are the same as each other.

Specifically, each protruding portion 54 protrudes outward in the radial direction of the rotary blade 5 (inner portion 51), in other words, each protruding portion 54 protrudes in a direction perpendicular to the center line L1 of the rotary blade 5. A center line L2 (see FIG. 10) extending in the protruding direction of the protruding portion 54 intersects the center P (center line L1) of the rotary blade 5. As shown in FIG. 10, the protruding portion 54 has a first side blade 57 facing in a first direction F1 in the circumferential direction around the center P, and a second side blade 58 facing in a direction F2 opposite to the first direction F1 in the circumferential direction. These side blades 57 and 58 face in directions opposite to each other with the center line L2 as a boundary. In addition, the side blades 57 and 58 are formed so as to be shaped symmetrically with respect to the center line L2.

As shown in FIG. 14, the first side blade 57 is formed in a tapered shape whose width in the up-down direction gradually decreases toward the first direction F1. Specifically, the first side blade 57 includes a first inclined surface 57a and a second inclined surface 57b. These inclined surfaces 57a and 57b are each formed so as to be inclined relative to a virtual horizontal plane perpendicular to the center line L1 of the rotary blade 5. The first inclined surface 57a faces upward and is gradually displaced downward as extending toward the first direction F1. The second inclined surface 57b faces downward and is gradually displaced upward as extending toward the first direction F1. The first inclined surface 57a and the second inclined surface 57b are connected to each other at a tip 57c on the first direction F1 side. The tip 57c is located at the middle of the width in the up-down direction of the protruding portion 54. In addition, the tip 57c is formed in a sharp shape. That is, the angle between the first inclined surface 57a and the second inclined surface 57b at the tip 57c is set to an acute angle (angle smaller than 90°).

The second side blade 58 has a first inclined surface 58a, a second inclined surface 58b and a tip 58c which are shaped symmetrically with respect to the first side blade 57 about the center line L2 of the protruding portion 54.

The first inclined surface 57a of the first side blade 57 and the first inclined surface 58a of the second side blade 58 are directly connected (i.e., without a flat surface perpendicular to the center line L1 of the rotary blade 5 therebetween). A connection portion 59 between the first inclined surface 57a and the first inclined surface 58a draws a straight line extending in the radial direction when viewed in the plan view in FIG. 10.

The second inclined surface 57b of the first side blade 57 and the second inclined surface 58b of the second side blade 58 are directly connected (i.e., without a flat surface perpendicular to the center line L1 of the rotary blade 5 therebetween). A connection portion 60 between the second inclined surface 57b and the second inclined surface 58b draws a straight line extending in the radial direction when viewed in a plan view.

As described above, in this embodiment, the first side blade 57 and the second side blade 58, which are formed in a back-to-back relationship, have common edge portions 59 and 60 at edge portions on the opposite side to each tapering direction, and these edge portions 59 and 60 draw straight lines along the radial direction of the rotary blade 5.

As shown in FIG. 14, a cross-section, perpendicular to the center line L2, of the protruding portion 54 has a rhombic shape (substantially a rhombic shape). In addition, the protruding portion 54 has a surface 61 at the tip in the protruding direction thereof (direction of the center line L2) (see FIG. 9 and FIG. 11). The tip surface 61 is formed in a non-sharp shape, and specifically, is formed in a rhombic shape as in the cross-section in FIG. 14. The tip surface 61 may be formed as a flat surface perpendicular to the center line L2, or may be formed as a curved surface along the circumferential direction of the rotary blade 5 or the like.

The protruding portion 54 is formed in a columnar shape. The columnar shape refers to a shape having a cross-section with an aspect ratio of 0.3 to 3.0. Therefore, the ratio between a vertical width G1 and a horizontal width G2 in the cross-section in FIG. 14 of the protruding portion 54 is 0.3 to 3.0.

Each cut portion 55 is formed so as to be recessed in a U-shape toward the center P side when viewed in the plan view in FIG. 10. The cut portion 55 is formed in a shape symmetric with respect to a center line L3 thereof. The center line L3 is a line that extends in the radial direction of the rotary blade 5 (inner portion 51) and that intersects the center P of the rotary blade 5.

Specifically, the cut portion 55 has the first side blade 57 of one protruding portion 54, the second side blade 58 of a protruding portion 54 adjacent thereto, and a bottom blade 62. The bottom blade 62 is formed in an arc shape between the first side blade 57 of the one protruding portion 54 and the second side blade 58 of the protruding portion 54 adjacent thereto. As shown in FIG. 11 and FIG. 13, the bottom blade 62 includes a first inclined surface 62a and a second inclined surface 62b. These inclined surfaces 62a and 62b are each formed so as to be inclined relative to a virtual horizontal plane perpendicular to the center line L1 of the rotary blade 5. The first inclined surface 62a faces upward and is gradually displaced downward as extending outward in the radial direction of the rotary blade 5 or as approaching the center line L3 of the cut portion 55. The second inclined surface 62b faces downward and is gradually displaced upward as extending outward in the radial direction of the rotary blade 5 or as approaching the center line L3 of the cut portion 55. The first inclined surface 62a and the second inclined surface 62b are connected to each other at a position on the radially outer side of the rotary blade 5 or a position closer to the center line L3. A tip 62c (see FIG. 11 and FIG. 13) which is a connection portion therebetween is located at the middle of the width in the up-down direction of the rotary blade 5 (inner portion 51). In addition, the tip 62c is formed in a sharp shape. That is, the angle between the first inclined surface 62a and the second inclined surface 62b at the tip 62c is set to an acute angle (angle smaller than 90°).

The first inclined surface 62a of the bottom blade 62 is continuous with the first inclined surfaces 57a and 58a of the protruding portions 54 opposing each other with the cut portion 55 therebetween. That is, the first inclined surfaces 57a and 58a of the protruding portions 54 and the first inclined surface 62a of the bottom blade 62 form a continuous surface that is curved in a U-shape when viewed in a plan view.

Similarly, the second inclined surface 62b of the bottom blade 62 is continuous with the second inclined surfaces 57b and 58b of the protruding portions 54 opposing each other with the cut portion 55 therebetween. That is, the second inclined surfaces 57b and 58b of the protruding portions 54 and the second inclined surface 62b of the bottom blade 62 form a continuous surface that is curved in a U-shape when viewed in a plan view.

The tip 62c of the bottom blade 62 is continuous with the tips 57c and 58c of the side blades 57 and 58 opposing each other with the cut portion 55 therebetween. That is, the tips 57c and 58c of the side blades 57 and 58 and the tip 62c of the bottom blade 62 form a continuous sharp portion that is curved in a U-shape when viewed in a plan view.

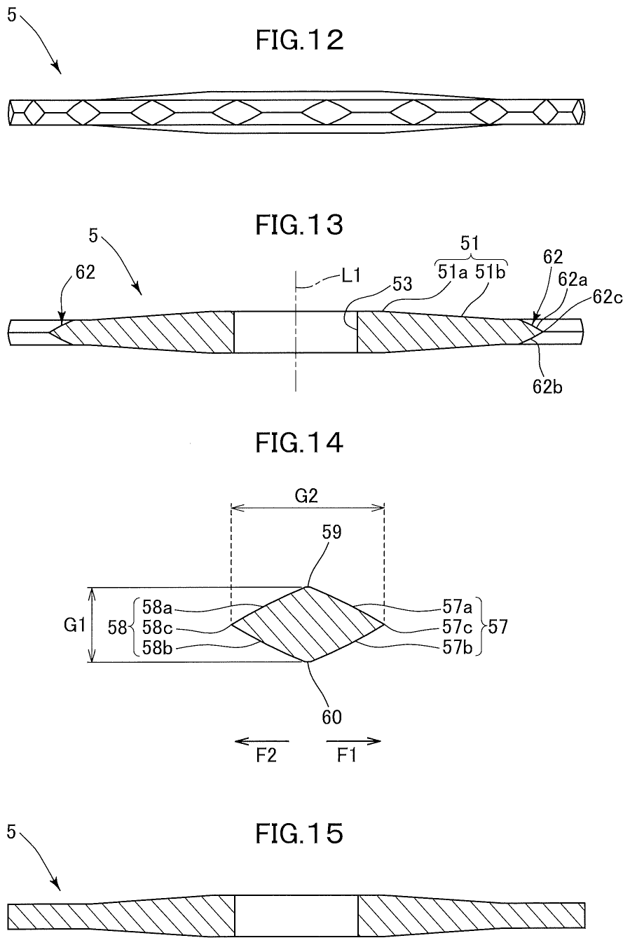

Each rotary blade 5 is formed in a vertically symmetrical shape. That is, a bottom view of the rotary blade 5 is shown so as to be symmetrical with the plan view (top view) in FIG. 10. In addition, the rotary blade 5 is formed in a shape having 18° rotational symmetry (20 times rotational symmetry) around the center P. A back view of the rotary blade 5 is shown so as to be symmetrical with a front view in FIG. 11. A left side view of the rotary blade 5 is shown so as to be symmetrical with a right side view in FIG. 12.

The rotary blades 5 can be attached to and detached from the upper plate 2 and the lower plate 3. That is, the rotary blades 5 can be detached from the upper plate 2 and the lower plate 3 by unfastening the guide pins 4 and the nuts 6 and separating the upper plate 2 and the lower plate 3 from each other. In addition, after the upper plate 2 and the lower plate 3 are separated from each other, and the rotary blades 5 are turned upside down, the rotary blades 5 can be attached to the upper plate 2 and the lower plate 3 again. Furthermore, the rotary blades 5 can be replaced with new rotary blades 5.

Each rotary blade 5 is provided such that the blade portion 56 protrudes outward from the cutout portion 35 (second portion 35b) of the lower plate 3 when the rotary blade 5 is at the outermost position in FIG. 5. In addition, when being at the outermost position in FIG. 5, the blade portion 56 may protrude outward slightly from the virtual circle 200 (for example, by an amount equal to or smaller than a width D, in the radial direction of the rotary blade 5, of the blade portion 56). In this case, the virtual circle 200 overlaps (intersects) only the blade portion 56 of the rotary blade 5 when viewed in a plan view. The outermost position in FIG. 5 corresponds to the position of the rotary blade 5 when the upper plate 2 and the lower plate 3 are rotating and no object such as weeds is in contact with the blade portion 56. In addition, when being at the outermost position in FIG. 5, only the outer periphery portion 52 in which the blade portion 56 is formed may protrude outward from the cutout portion 35, and the inner portion 51 may be located inward of the cutout portion 35. Moreover, when being at the innermost position in FIG. 6, the blade portion 56 may be located inward of the virtual circle 200, and may be located outward of the cutout portion 35 (second portion 35b).

Hereinafter, the advantageous effects of this embodiment will be described. Each rotary blade 5 rotates around the rotation center line L0 of the upper plate 2 and the lower plate 3 as the upper plate 2 and the lower plate 3 rotate. At this time, the rotary blade 5 rotates in a state where the rotary blade 5 is locked at the outermost position shown in FIG. 5 due to centrifugal force. If the rotary blade 5 hits a hard object (obstacle) such as a tree, a wall, or a fence during rotation, the rotary blade 5 can be displaced to a position on the inner side with respect to the outermost position in FIG. 5 (e.g., to the innermost position in FIG. 6). In addition, if the rotary blade 5 hits a hard object (obstacle) such as a tree, a wall, or a fence during rotation, the rotary blade 5 can be displaced in the direction E2 opposite to the rotation direction E1 of the upper plate 2 and the lower plate 3 around the guide pin 4. Accordingly, the impact of the obstacle on the blade portion 56 can be reduced, so that damage to the blade portion 56 or the obstacle can be inhibited.

Since the lower plate 3 has the outer periphery portion 33 extending radially outward further from the body portion 32 (portion corresponding to the diameter of the upper plate 2), stones can be pushed outward by the outer periphery portion 33. Specifically, since the arc portions 34 having a large diameter are provided at positions, between the plurality of rotary blades 5, on the outer periphery of the lower plate 3 (outer periphery portion 33), small stones, etc., can be removed to the outer side with respect to the rotation trajectory of the rotary blades 5 by the arc portions 34. Accordingly, small stones, etc., can be inhibited from hitting the blade portions 56, so that damage to the blade portions 56 and scattering of the small stones, etc., to the surrounding area can be inhibited. In addition, since each arc portion 34 is defined to have a large diameter such that the blade portion 56 protrudes slightly from the virtual circle 200 (when the rotary blade 5 is at the outermost position) or the blade portion 56 retracts inside the virtual circle 200 (when the rotary blade 5 is at the innermost position), small stones, etc., can be more effectively removed by the arc portion 34.

When the rotary blade 5 is at the outermost position in FIG. 5, the blade portion 56 merely protrudes slightly from the virtual circle 200 (specifically, e.g., by an amount equal to or smaller than the protrusion width D of the blade portion 56), so that, even if a small stone or the like comes toward the rotary blade 5, the small stone or the like can be inhibited from coming into contact with the blade portion 56. When the rotary blade 5 is at the innermost position in FIG. 6, the blade portion 56 retracts inside the virtual circle 200, so that, even if an obstacle comes into contact with the blade portion 56, the contact can be immediately eliminated.

Since the cutout portion 35 is provided around each rotary blade 5 on the outer periphery of the lower plate 3 (outer periphery portion 33), the diameter of the lower plate 3 (in other words, the distance between the arc portion 34 and the rotation center of the lower plate 3) can be increased while the blade portion 56 of the rotary blade 5 is allowed to protrude to the outside of the lower plate 3. Since the diameter of the lower plate 3 (arc portion 34) can be increased, an obstacle such as stones can be pushed outward by the arc portion 34, so that stones, etc., can be inhibited from hitting the blade portion 56. In addition, weeds can be efficiently guided to the blade portion 56 by the cutout portion 35. That is, weeds (especially hard woody weeds) bend outward in the radial direction of the lower plate 3 when coming into contact with the arc portion 34, but when the contact with the arc portion 34 is eliminated at the position of the cutout portion 35, the weeds are displaced toward the cutout portion 35 by the reaction of the bending. Accordingly, the weeds can be guided along the cutout portion 35 to the blade portion 56, and can be efficiently cut.

Since the second portion 35b of the cutout portion 35 is formed so as to change the direction to the side approaching the virtual circle 200 from the first portion 35a and is formed in an arc shape gradually approaching the virtual circle 200, stones can be inhibited from being caught by the cutout portion 35 and being caused to fly.

Since the space between the upper plate 2 and the lower plate 3 is closed by the side surface portion 22 of the upper plate 2, weeds, etc., can be inhibited from entering the space.

Since the lower surfaces of the body bottom portion 32a and the outer periphery portion 33 of the lower plate 3 are each formed in an inclined shape that is displaced upward from the inner side toward the outer side (see FIG. 3), the contact area between the lower plate 3 and the ground can be reduced. Accordingly, it can be made easier to move the weed cutting blade device 1 along the ground. The lower surface of the lower plate 3 may be displaced upward in a straight shape from the inner side toward the outer side in the radial direction, or may be displaced upward in a curved shape. In addition, the lower surface of the lower plate 3 may be displaced upward in a straight shape from the inner side toward the outer side in the radial direction, and from the middle of the displacement, the lower surface of the lower plate 3 may be displaced upward in a straight shape at an inclination angle different from the previous inclination angle, as shown in the example in FIG. 3. That is, the inclination angle of the lower surface of the lower plate 3 may be changed stepwise.

Since the upper surface 21a of the upper plate 2 is formed as a surface having no irregularities or steps (e.g., a flat surface perpendicular to the rotation center line L0), weeds can be inhibited from becoming entangled with the upper surface 21a.

Since the number of blade portions 56 (protruding portions 54) of the rotary blade 5 is as many as 20, the distribution of wear of the blade portion 56 can be increased, so that the durability of the blade portion 56 can be improved.

Since each rotary blade 5 has a vertically symmetrical shape, if the first side blades 57 on the rotation direction E1 side of the upper plate 2 and the lower plate 3 are worn out, the second side blades 58 which are not worn out can be directed to the rotation direction E1 side by turning the rotary blade 5 upside down and attaching the rotary blade 5 again, so that the second side blades 58 can be mainly used to cut weeds.

Since each tip 61 (see FIG. 9 and FIG. 11) in the protruding direction of the blade portion 56 is formed as a surface (in a non-sharp shape), the pressure acting on the blade portion 56 when the tip 61 hits a hard weed, a tree trunk, or the like can be reduced, and the side blades 57 and 58 can be inhibited from being chipped off. Accordingly, the durability of the blade portion 56 can be improved.

As shown in FIG. 14, the inclined surfaces 57a and 57b of the first side blades 57 of the blade portion 56 are directly connected to the inclined surfaces 58a and 58b of the second side blades 58 having a back-to-back relationship with the first side blades 57, in other words, the first side blades 57 and the second side blades 58 have common edge portions 59 and 60. Thus, the width, along the circumferential direction of the rotary blade 5, of each protruding portion 54 can be reduced. Accordingly, the number of protruding portions 54 can be increased while the width of the cut portion 55 is inhibited from becoming smaller. When the number of protruding portions 54 is large, the durability of each of the blades 57 and 58 of the protruding portions 54 can be improved.

Since the blade portion 56 includes the bottom blades 62 in addition to the side blades 57 and 58, the force to cut weeds can be further increased.

Since the inner portion 51 of each rotary blade 5 is formed in a slightly inclined shape (see FIG. 13), the blade portion 56 can be inhibited from coming into contact with the upper plate 2 and the lower plate 3. In addition, for example, when an obstacle hits the rotary blade 5, the rotary blade 5 can be easily rotated around the guide pin 4 such that the impact on the rotary blade 5 is reduced.

Since the blade portions (protruding portions 54) of the rotary blade 5 are formed in a columnar shape, the rigidity and the durability thereof can be made higher than when the blade portions (protruding portions 54) are formed in a plate shape.

### Second Embodiment

A second embodiment of this disclosure will be described next, focusing on the parts different from the above embodiment. A weed cutting blade device of this embodiment is the same as the weed cutting blade device 1 of the first embodiment, except that a rotary blade 7 shown in FIG. 16 to FIG. 22 is included instead of each rotary blade 5 of the first embodiment. The rotary blade 7 is the same as the rotary blade 5 of the first embodiment, except that the number and the shapes of protruding portions 71 forming a blade portion are different from the number and the shapes of protruding portions 54 of the first embodiment. In addition, the rotary blade 7 is formed in a vertically symmetrical shape and a rotationally symmetrical shape (shape having 12 times rotational symmetry, shape having 30° rotational symmetry).

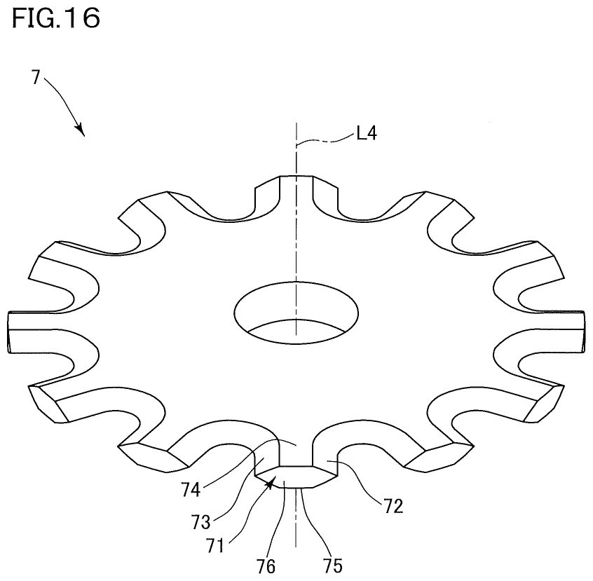

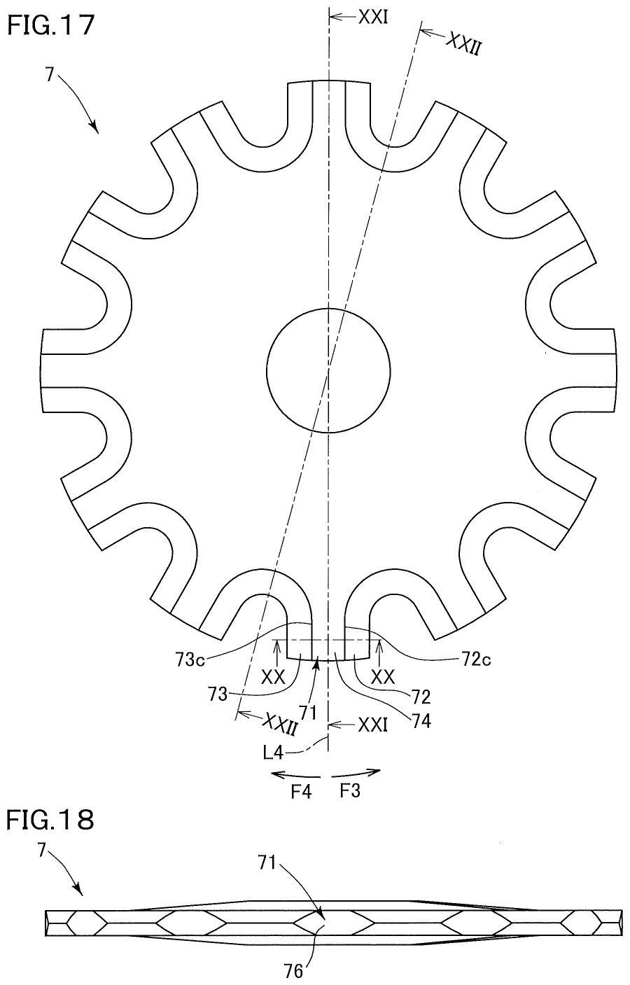

A plurality of protruding portions 71 are formed at equal intervals in the circumferential direction around a center line L4 of the rotary blade 7, on the outer periphery of the rotary blade 7 so as to protrude outward in the radial direction of the rotary blade 7 (direction perpendicular to the center line L4 (see FIG. 16)). In this embodiment, 12 protruding portions 71 are formed. The plurality of protruding portions 71 are formed in shapes that are the same as each other. Each protruding portion 71 has a first side blade 72 facing in a first direction F3 (see FIG. 17 and FIG. 20) in the circumferential direction around the center line L4 of the rotary blade 7, and a second side blade 73 facing in a second direction F4 opposite to the first direction F3.

The first side blade 72 is formed in the same manner as the first side blade 57 of the first embodiment. Specifically, as shown in FIG. 20, the first side blade 72 includes a first inclined surface 72a and a second inclined surface 72b, and is formed in a tapered shape in which the width between the inclined surfaces 72a and 72b gradually decreases toward the first direction F3.

The second side blade 73 is formed in the same manner as the second side blade 58 of the first embodiment. Specifically, as shown in FIG. 20, the second side blade 73 includes a first inclined surface 73a and a second inclined surface 73b, and is formed in a tapered shape in which the width between the inclined surfaces 73a and 73b gradually decreases toward the second direction F4.

As shown in FIG. 20, surfaces 74 and 75 extending in the circumferential direction of the rotary blade 7 are interposed between the first side blade 72 and the second side blade 73. That is, the surface 74 is interposed between the first inclined surface 72a of the first side blade 72 and the first inclined surface 73a of the second side blade 73. The surface 75 is interposed between the second inclined surface 72b of the first side blade 72 and the second inclined surface 73b of the second side blade 73. These surfaces 74 and 75 may be flat surfaces perpendicular to the center line L4 of the rotary blade 7. The surface 74 faces upward from the rotary blade 7. The other surface 75 faces downward from the rotary blade 7. An upper edge portion 72c (see FIG. 17 and FIG. 20) of the first side blade 72 and an upper edge portion 73c (see FIG. 17 and FIG. 20) of the second side blade 73 extend parallel to each other along the radial direction of the rotary blade 7. Similarly, a lower edge portion 72d (see FIG. 20) of the first side blade 72 and a lower edge portion 73d (see FIG. 20) of the second side blade 73 extend parallel to each other along the radial direction of the rotary blade 7. A cross-section, perpendicular to the radial direction of the rotary blade 7, of each protruding portion 71 has a hexagonal shape (substantially a hexagonal shape) (see FIG. 20). Thus, in this embodiment, there is no common edge portion between the first side blade 72 and the second side blade 73 which are located in a back-to-back relationship.

As shown in FIG. 16 and FIG. 18, each protruding portion 71 has a surface 76 at a tip in the protruding direction thereof. The tip surface 76 is formed in a non-sharp shape, and specifically, is formed in a hexagonal shape (substantially a hexagonal shape) as in the cross-section in FIG. 20. The tip surface 76 may be formed as a flat surface perpendicular to a center line of the protruding portion 71, or may be formed as a curved surface along the circumferential direction of the rotary blade 7 or the like.

According to this embodiment, the same effects as those of the first embodiment are achieved. In addition, since the surfaces 74 and 75 are interposed between the first side blade 72 and the second side blade 73, the rigidity of the protruding portion 71 (blade portion) can be increased, so that the durability of the protruding portion 71 can be increased.

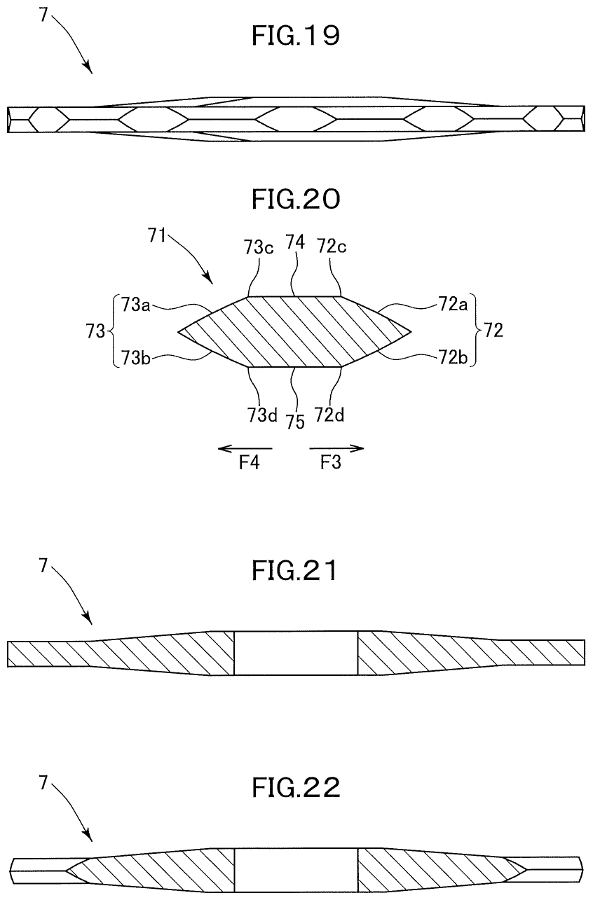

A bottom view of the rotary blade 7 is shown so as to be symmetrical with a plan view (top view) in FIG. 17. A back view of the rotary blade 7 is shown so as to be symmetrical with a front view in FIG. 18. A left side view of the rotary blade 7 is shown so as to be symmetrical with a right side view in FIG. 19.

### Third Embodiment

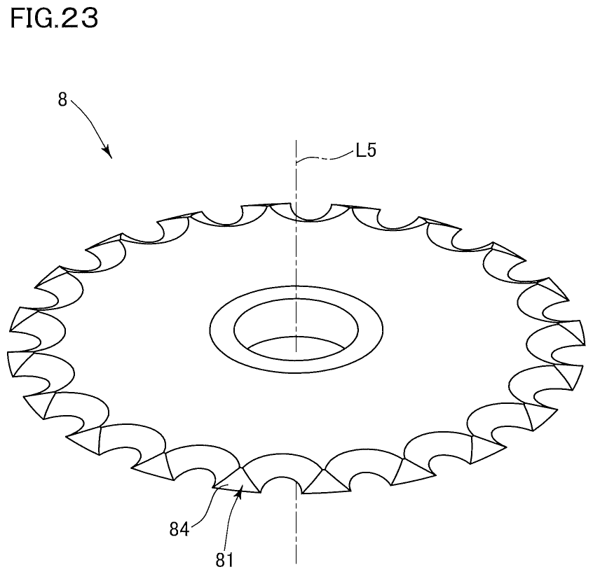

A third embodiment of this disclosure will be described next, focusing on the parts different from the above embodiments. A weed cutting blade device of this embodiment is the same as the weed cutting blade device 1 of the first embodiment, except that a rotary blade 8 shown in FIG. 23 to FIG. 29 is included instead of each rotary blade 5 of the first embodiment. The rotary blade 8 is the same as the rotary blade 5 of the first embodiment, except that the shapes of protruding portions 81 forming a blade portion are different from the shapes of the protruding portions 54 of the first embodiment. In addition, the rotary blade 8 is formed in a vertically symmetrical shape and a rotationally symmetrical shape (shape having 20 times rotational symmetry, shape having 18° rotational symmetry).

A plurality of protruding portions 81 are formed at equal intervals in the circumferential direction around a center line L5 of the rotary blade 8, on the outer periphery of the rotary blade 8 so as to protrude outward in the radial direction of the rotary blade 8 (direction perpendicular to the center line L5 (see FIG. 23)). In this embodiment, 20 protruding portions 81 are formed. The plurality of protruding portions 81 are formed in shapes that are the same as each other. Each protruding portion 81 has a first side blade 82 facing in a first direction F5 (see FIG. 24 and FIG. 29) in the circumferential direction around the center line L5 of the rotary blade 8, and a second side blade 83 facing in a second direction F6 (see FIG. 24 and FIG. 29) opposite to the first direction F5.

The first side blade 82 is formed in the same manner as the first side blade 57 of the first embodiment. Specifically, as shown in FIG. 29, the first side blade 82 includes a first inclined surface 82a and a second inclined surface 82b, and is formed in a tapered shape in which the width between the inclined surfaces 82a and 82b gradually decreases toward the first direction F5.

The second side blade 83 is formed in the same manner as the second side blade 58 of the first embodiment. Specifically, as shown in FIG. 29, the second side blade 83 includes a first inclined surface 83a and a second inclined surface 83b, and is formed in a tapered shape in which the width between the inclined surfaces 83a and 83b gradually decreases toward the second direction F6.

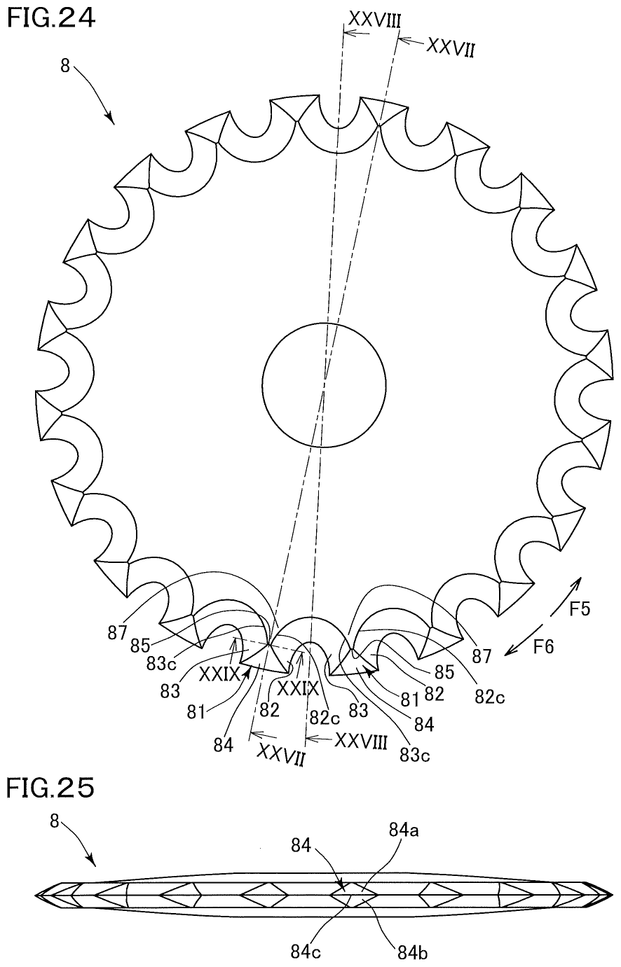

The protruding portion 81 has a tip blade 84 at a tip in the protruding direction thereof (see FIG. 23, FIG. 24, and FIG. 27). That is, the tip of the protruding portion 81 is formed in a sharp shape. As shown in FIG. 27, the tip blade 84 is formed in a tapered shape whose width in the up-down direction gradually decreases toward the protruding direction of the protruding portion 81 (outer side in the radial direction of the rotary blade 8). Specifically, the tip blade 84 includes a first inclined surface 84a and a second inclined surface 84b. These inclined surfaces 84a and 84b are formed so as to be inclined relative to a virtual horizontal plane perpendicular to the center line L5 of the rotary blade 8. The first inclined surface 84a faces upward and is gradually displaced downward as extending toward the protruding direction of the protruding portion 81. The second inclined surface 84b faces downward and is gradually displaced upward as extending toward the protruding direction of the protruding portion 81. The first inclined surface 84a and the second inclined surface 84b are connected to each other at a tip 84c in the protruding direction of the protruding portion 81. The tip 84c is located at the middle of the width in the up-down direction of the protruding portion 81. The tip 84c is also formed in a sharp shape. That is, the angle between the first inclined surface 84a and the second inclined surface 84b at the tip 84c is set to an acute angle (angle smaller than 90°). In addition, the tip 84c draws a straight line or a curved line along the circumferential direction of the rotary blade 8 (see also FIG. 25).

The first inclined surface 84a and the second inclined surface 84b are each formed in substantially a triangular shape (shape having three sides) when viewed in a plan view in FIG. 24 and a front view in FIG. 25. A first side of the first inclined surface 84a forms the above-described tip 84c. A second side of the first inclined surface 84a forms an edge portion of the first inclined surface 82a (see FIG. 29) of the first side blade 82. A third side of the first inclined surface 84a forms an edge portion of the first inclined surface 83a (see FIG. 29) of the second side blade 83.

A first side of the second inclined surface 84b forms the above-described tip 84c. A second side of the second inclined surface 84b forms an edge portion of the second inclined surface 82b (see FIG. 29) of the first side blade 82. A third side of the second inclined surface 84b forms an edge portion of the second inclined surface 83b (see FIG. 29) of the second side blade 83.

Thus, the first inclined surface 82a of the first side blade 82, the first inclined surface 83a of the second side blade 83, and the first inclined surface 84a of the tip blade 84 have a common edge portion 85 (see FIG. 24 and FIG. 29), and this edge portion 85 is in the form of a point when viewed in the plan view in FIG. 24. In addition, the second inclined surface 82b of the first side blade 82, the second inclined surface 83b of the second side blade 83, and the second inclined surface 84b of the tip blade 84 have a common edge portion 86 (see FIG. 29), and this edge portion 86 is in the form of a point.

A surface 87 (see FIG. 24) is interposed between the first inclined surface 82a of the first side blade 82 and the first inclined surface 83a of the second side blade 83. The surface 87 may be a flat surface perpendicular to the center line L5 of the rotary blade 8. The interval between an upper edge portion 82c (see FIG. 24) of the first side blade 82 (first inclined surface 82a) and an upper edge portion 83c (see FIG. 24) of the second side blade 83 (first inclined surface 83a) which form an edge portion of the surface 87 gradually decreases toward the tip of the protruding portion 81. The upper edge portion 82c and the upper edge portion 83c finally converge at a single point 85.

Similarly, a surface (not shown) is interposed between the second inclined surface 82b of the first side blade 82 and the second inclined surface 83b of the second side blade 83. The interval between a lower edge portion (not shown) of the first side blade 82 (second inclined surface 82b) and a lower edge portion (not shown) of the second side blade 83 (second inclined surface 83b) which form an edge portion of this surface gradually decreases toward the tip of the protruding portion 81. These lower edge portions finally converge at a single point 86 (see FIG. 29).

According to this embodiment, the same effects as those of the first embodiment are achieved. In addition, since the rotary blade 8 has the tip blades 84, weeds can also be cut by the tip blades 84. In addition, since the first side blade 82 and the second side blade 83, which are located in a back-to-back relationship, have the common edge portions 59 and 60 at the edge portions on the opposite side to each tapering direction, the width, along the circumferential direction of the rotary blade 8, of the protruding portion 81 can be reduced. Accordingly, the number of protruding portions 81 can be increased while the width of the cut portion between the protruding portions 81 is inhibited from becoming smaller. Since the number of protruding portions 81 is increased, the durability of each of the blades 82 to 84 of the protruding portions 81 can be increased.

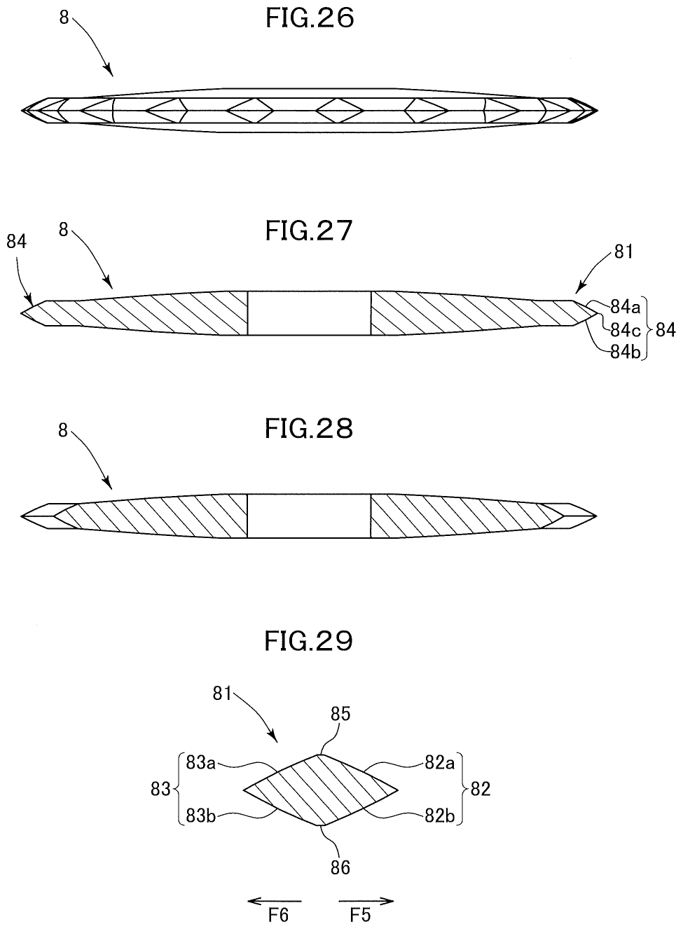

A bottom view of the rotary blade 8 is shown so as to be symmetrical with the plan view (top view) in FIG. 24. A back view of the rotary blade 8 is shown so as to be symmetrical with the front view in FIG. 25. A left side view of the rotary blade 8 is shown so as to be symmetrical with a right side view in FIG. 26.

### Fourth Embodiment

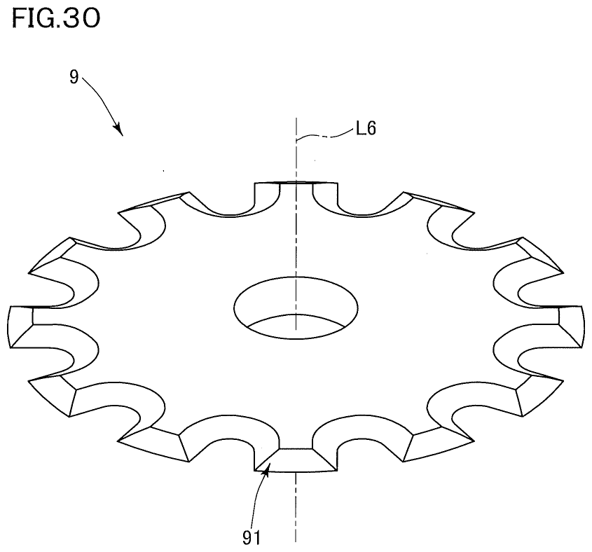

A fourth embodiment of this disclosure will be described next, focusing on the parts different from the above embodiments. A weed cutting blade device of this embodiment is the same as the weed cutting blade device 1 of the first embodiment, except that a rotary blade 9 shown in FIG. 30 to FIG. 36 is included instead of each rotary blade 5 of the first embodiment. The rotary blade 9 is the same as the rotary blade 5 of the first embodiment, except that the number and the shapes of protruding portions 91 forming a blade portion are different from the number and the shapes of protruding portions 54 of the first embodiment. In addition, the rotary blade 9 is formed in a vertically symmetrical shape and a rotationally symmetrical shape (shape having 12 times rotational symmetry, shape having 30° rotational symmetry).

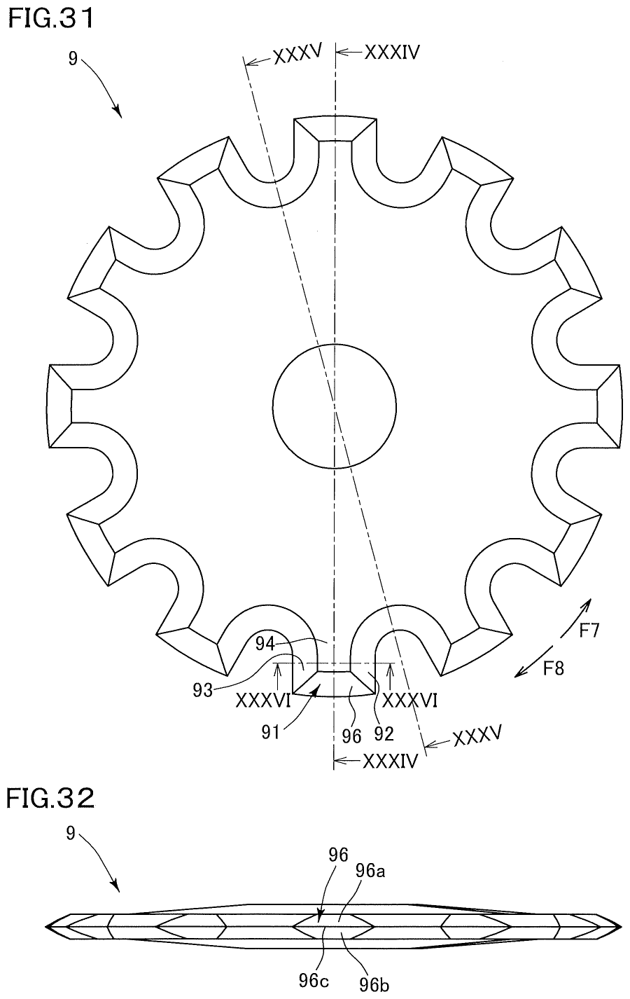

A plurality of protruding portions 91 are formed at equal intervals in the circumferential direction around a center line L6 of the rotary blade 9, on the outer periphery of the rotary blade 9 so as to protrude outward in the radial direction of the rotary blade 9 (direction perpendicular to the center line L6 (see FIG. 30)). In this embodiment, 12 protruding portions 91 are formed. The plurality of protruding portions 91 are formed in shapes that are the same as each other. Each protruding portion 91 has a first side blade 92 facing in a first direction F7 (see FIG. 31 and FIG. 36) in the circumferential direction around the center line L6 of the rotary blade 9, and a second side blade 93 facing in a second direction F8 (see FIG. 31 and FIG. 36) opposite to the first direction F7.

The first side blade 92 is formed in the same manner as the first side blade 57 of the first embodiment. Specifically, as shown in FIG. 36, the first side blade 92 includes a first inclined surface 92a and a second inclined surface 92b, and is formed in a tapered shape in which the width between the inclined surfaces 92a and 92b gradually decreases toward the first direction F7.

The second side blade 93 is formed in the same manner as the second side blade 58 of the first embodiment. Specifically, as shown in FIG. 36, the second side blade 93 includes a first inclined surface 93a and a second inclined surface 93b, and is formed in a tapered shape in which the width between the inclined surfaces 93a and 93b gradually decreases toward the second direction F8.

As shown in FIG. 36, surfaces 94 and 95 extending in the circumferential directions F7 and F8 of the rotary blade 9 are interposed between the first side blade 92 and the second side blade 93. These surfaces 94 and 95 are formed in the same manner as the surfaces 74 and 75 (see FIG. 20) of the second embodiment. In this embodiment, as in the second embodiment, there is no common edge portion between the first side blade 92 and the second side blade 93 which are located in a back-to-back relationship.

Each protruding portion 91 has a tip blade 96 at a tip in the protruding direction thereof (see FIG. 31 and FIG. 34). That is, the tip of the protruding portion 91 is formed in a sharp shape. The shape, in a cross-section in FIG. 34, of the tip blade 96 is formed in the same manner as the shape, in the cross-section in FIG. 27, of the tip blade 84 of the third embodiment.

An upper first inclined surface 96a and a lower second inclined surface 96b of the tip blade 96 are each formed in a trapezoidal shape when viewed in a front view in FIG. 32. The long base of this trapezoidal shape forms a tip sharp portion 96c (see FIG. 34) of the tip blade 96. The short base of the trapezoidal shape forms an edge portion of the surface 94 or 95. The inclined portions of the trapezoidal shape form edge portions of the first side blade 92 and the second side blade 93.

According to this embodiment, the same effects as those of the first embodiment are achieved. In addition, since each rotary blade 9 has the tip blades 96, weeds can also be cut by the tip blades 96. Moreover, since the surfaces 94 and 95 are interposed between the first side blade 92 and the second side blade 93, the rigidity of the protruding portion 91 (blade portion) can be increased, so that the durability of the protruding portion 91 can be increased.

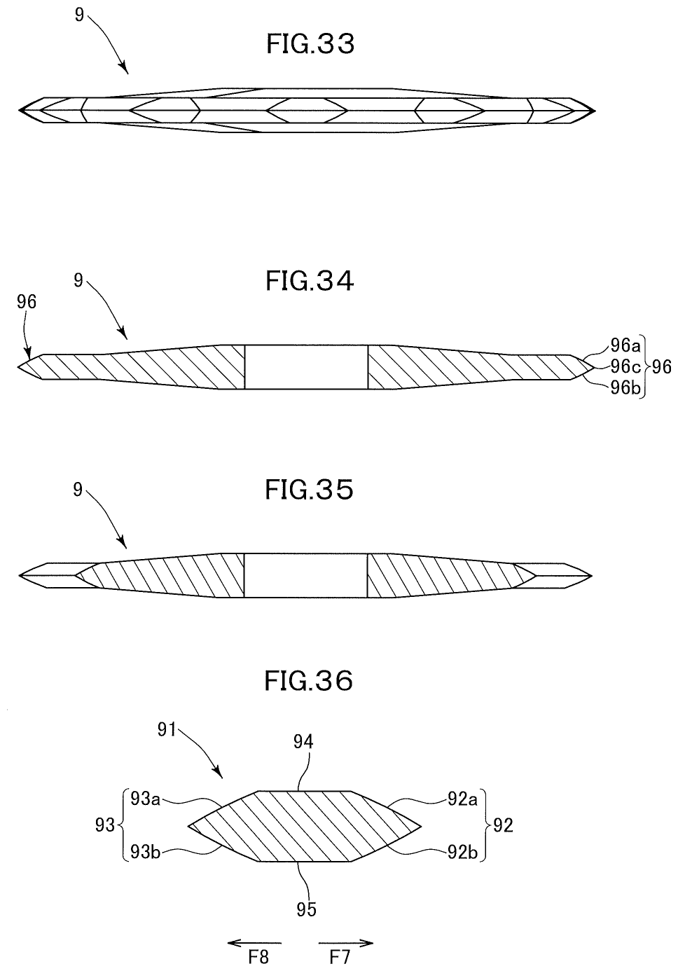

A bottom view of the rotary blade 9 is shown so as to be symmetrical with a plan view (top view) in FIG. 31. A back view of the rotary blade 9 is shown so as to be symmetrical with the front view in FIG. 32. A left side view of the rotary blade 9 is shown so as to be symmetrical with a right side view in FIG. 33.

### Fifth Embodiment

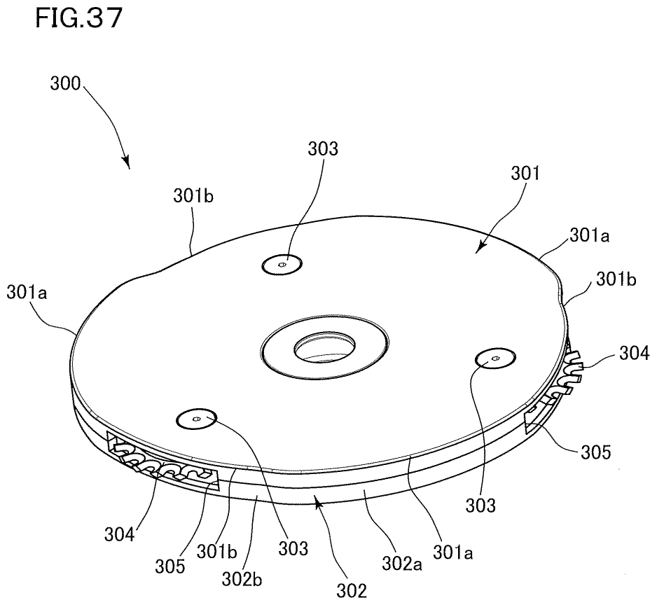

A fifth embodiment of this disclosure will be described next, focusing on the parts different from the above embodiments. In the above embodiments, the example in which the upper plate has a diameter smaller than that of the lower plate is illustrated. However, in this embodiment, an example in which the upper plate has the same diameter as the lower plate and a cutout is formed around each rotary blade on the outer periphery of the upper plate will be described. FIG. 37 shows a weed cutting blade device 300 of this embodiment. The weed cutting blade device 300 includes an upper plate 301, a lower plate 302, guide pins 303, and rotary blades 304. The weed cutting blade device 300 is the same as the weed cutting blade device 1 of the first embodiment, except that the shapes of the upper plate 301 and the lower plate 302 are different from those of the first embodiment. That is, the guide pins 303 and the rotary blades 304 are the same as the guide pins 4 and the rotary blades 5 of the first embodiment. Each rotary blade 304 may be any of the rotary blades of the second to fourth embodiments.

The upper plate 301 and the lower plate 302 are formed in disk shapes having the same diameter, and have outer periphery shapes that are the same as each other. The outer periphery shapes of the upper plate 301 and the lower plate 302 are the same as the outer periphery shape of the lower plate 3 of the first embodiment. That is, the outer periphery of the upper plate 301 has arc portions 301a each formed in an arc shape centered on the rotation center of the upper plate 301, and cutout portions 301b shaped so as to be cut out with respect to a rotation trajectory (virtual circle) drawn by the arc portions 301a. Each arc portion 301a is formed in the same shape as each arc portion 34 of the first embodiment, for example. Each cutout portion 301b is formed in the same shape as each cutout portion 35 of the first embodiment, for example, and is formed at a position around each rotary blade 304. The upper surface of each upper plate 301 is formed as a flat surface as in the first embodiment.

The outer periphery of the lower plate 302 has arc portions 302a each formed in an arc shape centered on the rotation center of the lower plate 302, and cutout portions 302b shaped so as to be cut out with respect to a rotation trajectory (virtual circle) drawn by the arc portions 302a. Each arc portion 302a is formed in the same shape as each arc portion 34 of the first embodiment, for example. In addition, each arc portion 302a is formed in the same shape as each arc portion 301a of the upper plate 301. Each cutout portion 302b is formed in the same shape as each cutout portion 35 of the first embodiment, for example, and is formed at a position around each rotary blade 304. In addition, each cutout portion 302b is formed in the same shape as each cutout portion 301b of the upper plate 301. The lower plate 302 does not have a plate-shaped outer periphery portion that protrudes outward from the upper plate 301.

The upper plate 301 and the lower plate 302 are coupled by the guide pins 303 such that when viewed in a plan view, the arc portions 301a of the upper plate 301 and the arc portions 302a of the lower plate 302 coincide with each other, and the cutout portions 301b of the upper plate 301 and the cutout portions 302b of the lower plate 302 coincide with each other. Openings 305 for allowing the blade portions of the respective rotary blades 304 to protrude to the outside are formed in side surfaces of the upper plate 301 and the lower plate 302. The space between the upper plate 301 and the lower plate 302 is closed except for the openings 305.

Thus, in this embodiment as well, the same effects as those of the above embodiments can be obtained.

This disclosure is not limited to the above embodiments, and various modifications may be made. For example, in the above embodiments, the example in which the number of rotary blades is three has been described. However, the number of rotary blades may be any number, and may be one, may be two, or may be four or more. In addition, the number of blade portions (protruding portions) formed on the outer periphery of each rotary blade may be any number.

In the above embodiments, the example in which the closing portion (side surface) for closing the outer periphery of the space between the upper plate and the lower plate is provided to the upper plate has been described. However, such a closing portion may be provided to the lower plate, or may be provided to both the upper plate and the lower plate.

The rotary blade of this disclosure may be configured as follows.

A weed cutter rotary blade to be attached to a rotary plate of a weed cutter at a position eccentric from a rotation center of the rotary plate so as to rotate freely, the rotary blade having a disk shape, the rotary blade including
a plurality of protruding portions protruding outward in a radial direction of the disk shape, along an outer periphery of the disk shape, wherein
each of the protruding portions has
   a first side blade formed in a tapered shape whose vertical width gradually decreases toward a first direction in a circumferential direction of the disk shape, and
   a second side blade formed in a tapered shape whose vertical width gradually decreases toward a second direction opposite to the first direction in the circumferential direction of the disk shape, and
a tip in a protruding direction of each of the protruding portions is formed in a non-sharp shape.

In this case, the first side blade and the second side blade may have a common edge portion between the first side blade and the second side blade on an opposite side to a tapering direction.

In the case where the rotary blade is configured as described above, the rotary plate may have a shape other than those of the above-described embodiments, and for example, a lower plate (rotary plate) having no cutout portion formed on an outer periphery thereof may be adopted.

The weed cutting blade device of this disclosure may also be configured as follows.

A weed cutting blade device including:
an upper plate and a lower plate provided so as to rotate around a center;
a guide pin coupling the upper plate and the lower plate at a position eccentric from the center; and
a disk-shaped rotary blade provided between the upper plate and the lower plate so as to freely rotate around the guide pin as an axis, and having a blade portion on an outer periphery thereof, the blade portion protruding outward from the lower plate, wherein
the lower plate has an outer periphery portion protruding outward from the upper plate over an entire circumference around the center.

According to this, stones can be pushed outward by the outer periphery portion of the lower plate, so that stones can be inhibited from hitting the blade portion of the rotary blade. Accordingly, stones can be inhibited from being caused to fly.

### DESCRIPTION OF THE REFERENCE CHARACTERS

1, 300 weed cutting blade device
2, 301 upper plate
3, 302 lower plate
34, 301a, 302a arc portion
35, 301b, 302b cutout portion
4, 303 guide pin
5, 7, 8, 9, 304 rotary blade
53 center hole (mounting hole) of rotary blade
54, 71, 81, 91 protruding portion (blade portion) of rotary blade
200 virtual circle

What is claimed is:

1. A weed cutting blade device comprising:
an upper plate and a lower plate provided so as to rotate around a center;
a guide pin coupling the upper plate and the lower plate at a position eccentric from the center; and
a disk-shaped rotary blade provided between the upper plate and the lower plate so as to freely rotate around the guide pin as an axis, and having a blade portion on an outer periphery thereof, the blade portion protruding outward from the lower plate, wherein
an outer periphery of the lower plate includes an arc portion formed in an arc shape along a circumferential direction around the center, and a cutout portion shaped so as to be cut out with respect to a virtual circle which is a trajectory drawn by the arc portion as the lower plate rotates, and
the cutout portion is formed so as to overlap the blade portion of the rotary blade from a position on a front side with respect to the rotary blade in a rotation direction of the lower plate when viewed in a plan view.

2. The weed cutting blade device according to claim 1, wherein the upper plate or the lower plate has a side surface portion closing a space between the upper plate and the lower plate.

3. The weed cutting blade device according to claim 1, wherein the rotary blade is mounted on the guide pin so as to be movable between an outermost position at which the blade portion protrudes outside the virtual circle and an innermost position at which the blade portion retracts inside the virtual circle.

4. The weed cutting blade device according to claim 1, wherein
an end portion, located on the rotation direction side of the lower plate, of the cutout portion is defined as a front end,
an end portion, located on an opposite side to the rotation direction, of the cutout portion is defined as a rear end, and
the cutout portion includes a first portion forming a part thereof from the front end, and a second portion changing a direction to a side approaching the virtual circle from the first portion and extending to the rear end while overlapping the rotary blade when viewed in a plan view.

5. The weed cutting blade device according to claim 1, wherein at least an outer periphery side of a bottom surface of the lower plate is formed in an inclined shape displaced upward from an inner side toward an outer side.

6. The weed cutting blade device according to claim 1, wherein an upper surface of the upper plate is formed as a surface having no irregularities or steps.

7. The weed cutting blade device according to claim 1, wherein
the rotary blade has, along the outer periphery thereof, a plurality of protruding portions as the blade portion protruding outward in a radial direction of the rotary blade,
each of the protruding portions has
a first side blade formed in a tapered shape whose vertical width gradually decreases toward a first direction in a circumferential direction of the rotary blade, and
a second side blade formed in a tapered shape whose vertical width gradually decreases toward a second direction opposite to the first direction in the circumferential direction of the rotary blade, and
a tip in a protruding direction of each of the protruding portions is formed in a non-sharp shape.

8. The weed cutting blade device according to claim 7, wherein the first side blade and the second side blade have a common edge portion between the first side blade and the second side blade on an opposite side to a tapering direction.
